(19) United States
(12) Patent Application Publication
(10) Pub. No.: US 2020/0035093 A1
(43) Pub. Date: Jan. 30, 2020

(54) SYSTEMS AND METHODS FOR MANAGING VEHICLES USING PATTERN RECOGNITION

(71) Applicant: QUALCOMM Incorporated, San Diego, CA (US)

(72) Inventor: Abhinay KUKKADAPU, San Diego, CA (US)

(21) Appl. No.: 16/044,270

(22) Filed: Jul. 24, 2018

(51) Int. Cl. G08G 1/01; G08G 1/0967

(52) U.S. Cl. CPC G08G 1/0129; G08G 1/096775; G08G 1/0133; G08G 1/0112

(57) ABSTRACT

In general, traffic management technologies are described. An example server device includes a communication unit and processing circuitry. The communication unit receives movement data from a first set of vehicles traveling through a traffic zone. The processing circuitry is configured to determine a traffic pattern for the traffic zone based on the received movement data received, to generate movement instructions for the traffic zone based on the determined traffic pattern, and to transmit, via the communication unit, the movement instructions to a second set of vehicles traveling through the traffic zone, the second set of vehicles being different from the first set of vehicles.

### BACKGROUND

Vehicles are increasingly becoming more autonomous. That is, vehicles are beginning to become equipped to perform tasks that an occupant would normally perform. For instance, autonomous vehicles may perform various tasks without any occupant interaction, or at least, without real-time occupant interaction on an action-by-action basis. Levels of autonomy for vehicles have been defined with level zero generally indicating no automation up to levels four or five, which may refer to so-called “fully autonomous” vehicles.

Fully autonomous vehicles, which are categorized at level four or level five on the vehicle autonomy spectrum, represent a level of human interaction in which an individual need only specify a destination to which the fully autonomous vehicle is to drive. For instance, processing circuitry of fully autonomous vehicle may process various parameters to formulate navigation and driving operations for each discrete trip. For navigation purposes, a global positioning system (GPS) receiver of a fully autonomous vehicle may triangulate the vehicle's position by communicating with three satellites or more. In terms of driving operations, the processing circuitry of a fully autonomous vehicle may use sensing devices outfitted on the vehicle to determine proximity with other vehicles, with lane markers, the status of traffic lights, etc.

### SUMMARY

In general, this disclosure describes systems and methods for coordinating the movements of multiple semi or fully autonomous vehicles passing through or positioned within a finite space, referred to herein as a “traffic zone.” As described herein, the systems may utilize data provided by an initial set of vehicles through a traffic zone to coordinate dynamic pattern formation for subsequent vehicles traversing the traffic zone. Implementations of this disclosure are directed to crowdsourcing-based traffic management techniques implemented by a cloud-based computing system (e.g., one or more servers) that is in communication with multiple semi or fully autonomous vehicles. With the increasing level of autonomous function being deployed into commercially-available vehicles, computing servers of this disclosure may manage traffic throughout the entirety, or near-entirety, of a traffic zone.

In various implementations, a server device for managing vehicles may include a communication unit and processing circuitry. The communication unit may be configured to receive movement data from a first set of vehicles traveling through a traffic zone. The processing circuitry may be coupled to the communication unit and to the memory device. The processing circuitry may be configured to determine a traffic pattern for the traffic zone based at least in part on the movement data; generate movement instructions for the traffic zone based at least in part on the determined traffic pattern; and transmit, via the communication unit, the movement instructions to a second set of vehicles traveling through the traffic zone, the second set of vehicles being different from the first set of vehicles.

In some implementations, the determined traffic pattern is a first traffic pattern, and the processing circuit may be further configured to: determine whether the first traffic pattern is valid or invalid; and responsive to determining that the first traffic pattern is invalid, determine a second traffic pattern for the traffic zone, the second traffic pattern being different from the first traffic pattern.

In further implementations, the generated movement instructions are first movement instructions, and the processing circuit may be further configured to: generate second movement instructions for the traffic zone based at least on the determined second traffic pattern; and transmit, via the communication unit, the second movement instructions to a third set of vehicles traveling through the traffic zone, the third set of vehicles being different from the first set of vehicles and the second set of vehicles. In further implementations, the processing circuit may be configured to determine whether the first traffic pattern is valid or invalid based on age of the first traffic pattern or the movement data used to generate at least part of the first traffic pattern.

In some implementations, the determined traffic pattern is a first traffic pattern, and the processing circuit may be further configured to: determine whether the first traffic pattern is valid or invalid; and responsive to determining that the first traffic pattern is invalid, determine a second traffic pattern for the traffic zone, cease transmitting the movement instructions.

In some implementations, the determined traffic pattern is a first traffic pattern, and the communication unit may be further configured to receive, from at least a portion of the second set of vehicles traveling through the traffic zone, validity information indicating whether the first traffic pattern is valid or invalid, and the processing circuitry may be further configured to, responsive to the validity information indicating that the first traffic pattern is invalid, determine a second traffic pattern for the traffic zone, the second traffic pattern being different from the first traffic pattern. In further implementations, the generated movement instructions are first movement instructions, and the processing circuit may be further configured to: generate second movement instructions for the traffic zone based at least on the determined second traffic pattern; and transmit, via the communication unit, the second movement instructions to a third set of vehicles traveling through the traffic zone, the third set of vehicles being different from the first set of vehicles and the second set of vehicles.

In some implementations, the communication unit may be further configured to receive, from at least a portion of the second set of vehicles traveling through the traffic zone, validity information indicating whether the traffic pattern is valid or invalid, and the processing circuitry may be further configured to, responsive to the validity information indicating that the traffic pattern is invalid, cease transmitting the movement instructions.

In some implementations, to generate the movement instructions for the traffic zone may be based at least in part on the determined traffic pattern, and the processing circuitry may be configured to generate each respective movement instruction of the movement instructions based on a corresponding movement of the traffic pattern that is associated with a corresponding location associated with the respective movement instruction being generated.

In some implementations, to transmit the movement instructions to the second set of vehicles traveling through the traffic zone, the processing circuitry may be configured to: associate a respective subset of the movement instructions with a respective vehicle of the second set of vehicles; and transmit only the respective subset of the movement instructions to the respective associated vehicle.

In some implementations, to transmit the movement instructions to the second set of vehicles traveling through the traffic zone, the processing circuitry may be configured to transmit the movement instructions to each vehicle of the second set of vehicles.

In various implementations, a vehicle may include a communication unit, sensor hardware, and processing circuitry. The communication unit may be configured to receive movement instructions from a server device, the movement instructions being associated with a traffic zone. The sensor hardware may be configured to detect surrounding conditions in or near the traffic zone. The processing circuitry may be coupled to the sensor hardware and to the communication unit. The processing circuitry may be configured to: cause the vehicle to travel in the traffic zone based on the received movement instructions; determine movement data for the traffic zone based on the detected surrounding conditions; and transmit, via the communication unit, the movement data to the server device.

In some implementations, the processing circuitry may be further configured to: determine, based on the detected surrounding conditions, whether the received movement instructions are valid with respect to the traffic zone; and transmit, via the communication unit to the server device, validity information based on the determination of whether the received movement instructions are valid. In further implementations, the received movement instructions may be associated with a traffic pattern, and the validity information may indicate whether the traffic pattern is valid with respect to the traffic zone.

In various implementations, a method for managing vehicles via a server device may include receiving, via a communication unit of the server device, movement data from a first set of vehicles traveling through a traffic zone; determining, via a processing unit of the server device, a traffic pattern for the traffic zone based at least in part on the movement data; generating, via the processing unit, movement instructions for the traffic zone based at least in part on the determined traffic pattern; and transmitting the movement instructions to a second set of vehicles traveling through the traffic zone, the second set of vehicles being different from the first set of vehicles.

In various implementations, a method for managing a vehicle may include receiving, via a communication unit of the vehicle, movement instructions from a server device, the movement instructions being associated with a traffic zone; detecting, via sensor hardware of the vehicle, surrounding conditions in or near the traffic zone; causing, via a processing unit of the vehicle, the vehicle to travel in the traffic zone based on the received movement instructions; and determining, via the processing unit of the vehicle, movement data for the traffic zone based on the detected surrounding conditions; and transmitting the movement data to the server device.

### BRIEF DESCRIPTION OF DRAWINGS

The accompanying drawings, which are incorporated herein and constitute part of this specification, illustrate exemplary embodiments, and together with the general description given above and the detailed description given below, serve to explain the features of the various implementations.

FIG. 1 is a block diagram illustrating an example system, in which a server device communicates via a wireless network with multiple autonomous vehicles, according to various implementations.

FIGS. 2A-2C are conceptual diagrams illustrating traffic conditions and vehicle operations in a traffic zone at various instances of time according to various implementations.

FIG. 3 is a conceptual diagram illustrating a pattern-based instruction set that a server device of this disclosure may generate, based on movement data gathered from autonomous vehicles when positioned as shown in FIG. 2C, according to various implementations.

FIG. 4 is a conceptual diagram illustrating traffic pattern validity checking according to various implementations.

FIG. 5 is a conceptual diagram illustrating an aerial view of an autonomous vehicle according to various implementations.

FIG. 6 is a conceptual diagram illustrating an example pattern packet that one or more autonomous vehicles may upload to a server device according to various implementations.

FIG. 7 is a block diagram illustrating an example implementation of a pattern generation unit according to various implementations.

FIG. 8 is a flowchart illustrating an example process that a server device may perform according to various implementations.

FIG. 9 is a data flow diagram (DFD) that illustrates various pattern recognition functionalities according to various implementations.

FIG. 10 is a conceptual diagram illustrating various technologies that preprocessing and classification/regression devices may implement to perform aspects of pattern recognition and machine learning according to various implementations.

FIG. 11 illustrates a line graph that plots an efficiency percentage against a combination of feature extraction and classification parameters in a test case according to various implementations.

FIG. 12 is a flowchart illustrating an example process that a vehicle may perform according to various implementations.

### DETAILED DESCRIPTION

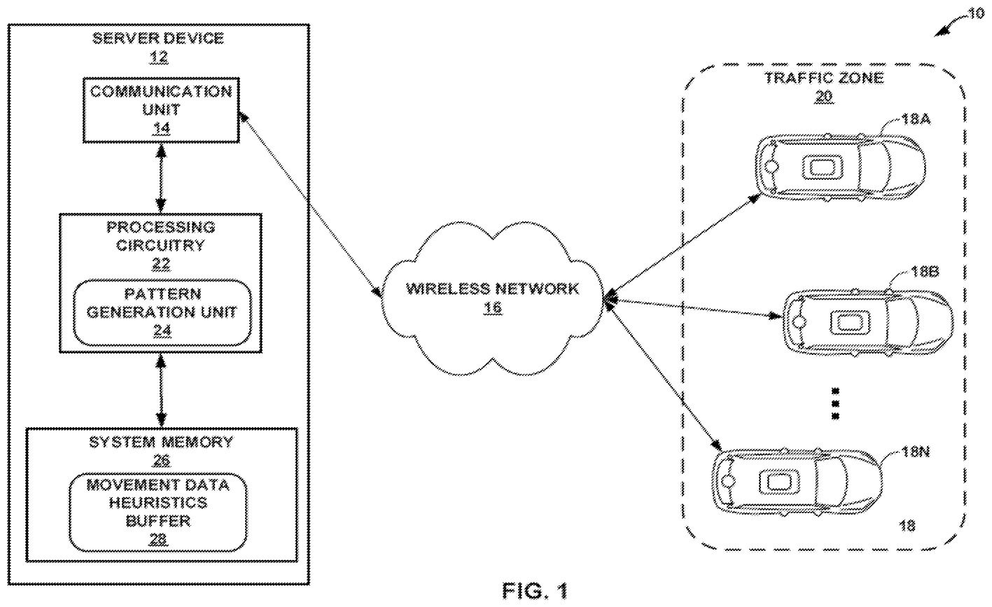

FIG. 1 is a block diagram illustrating an example system 10 in which a server device 12 communicates via a wireless network 16 with multiple autonomous vehicles 18A-18N (which may be collectively, in whole or in part, referred to as autonomous vehicles 18). The system 10 may represent an example in which a traffic management system includes at least one server device 12 that implements various techniques to perform various traffic management techniques with respect to a discrete physical area denoted by traffic zone 20. In some implementations, the server device 12 may represent a portion or the entirety of a “cloud-based” system for traffic management. That is, the server device 12 may be configured to formulate movement instructions and communicate the movement instructions to one or more of the autonomous vehicles 18.

The server device 12 may implement various implementations of this disclosure to gather, or crowdsource, traffic information from a set or multiple sets of vehicles (e.g., autonomous vehicles 18) traveling through the traffic zone 20. For instance, the server device 12 may use communication unit 14 to receive information (including, but not limited to, vehicle movement data) via over wireless network 16. It will be appreciated that the communication unit 14 may equip the server device 12 with either a direct interface or a transitive interface to the wireless network 16. In cases where the communication unit 14 represents a direct interface to the wireless network 16, the communication unit 14 may include, be, or be part of various wireless communication hardware, including, but not limited to, one or more of Bluetooth®, 3G, 4G, 5G, Wi-Fi®, and/or the like. In cases where the communication unit 14 represents a first link in a transitive interface to the wireless network 16, the communication unit 14 may represent wired communication hardware, wireless communication hardware (or some combination thereof), such as (but not limited to) any one or any combination of a network interface card (e.g., an Ethernet card and/or a Wi-Fi® dongle), USB hardware, an optical transceiver, a radio frequency transceiver, Bluetooth®, 3G, 4G, 5G, or Wi-Fi®, and so on.

While the communication unit 14 is illustrated as a single, standalone component of the server device 12, it will be appreciated that, in various implementations, the communication unit 14 may form multiple components, whether linked directly or indirectly. Moreover, portions of the communication unit 14 may be integrated with other components of the server device 12. At any rate, the communication unit 14 may represent network hardware that enables the server device 12 to reformat data (e.g., by packetizing or depacketizing) for communication purposes, and to signal and/or receive data in various formats over the wireless network 16.

The wireless network 16 may comprise implementations of the Internet or another public network. Although not shown for ease of illustration purposes, the wireless network 16 may incorporate network architecture comprising various intermediate devices that communicatively link the server device 12 to one or more of the autonomous vehicles 18. Examples of such devices include wireless communication devices such as (but not limited to) cellular telephone transmitters and receivers, Wi-Fi® radios, GPS transmitters, etc. Moreover, it will be appreciated that while the wireless network 16 delivers data to the autonomous vehicles 18 and collects data from the autonomous vehicles 18 using wireless “last mile” components, certain implementations of the wireless network 16 may also incorporate tangibly-connected devices, such as various types of intermediate-stage routers.

The communication unit 14 of the server device 12 may be communicatively coupled to processing circuitry 22 of the server device 12. The processing circuitry 22 may be formed in one or more microprocessors, application specific integrated circuits (ASICs), field programmable gate arrays (FPGAs), digital signal processors (DSPs), processing circuitry (including fixed function circuitry and/or programmable processing circuitry), or other equivalent integrated logic circuitry or discrete logic circuitry. The processing circuitry 22 may be communicatively coupled to system memory 26 of the server device 12.

The system memory 26 (also referred to as a memory device), in some implementations, may be described as a computer-readable storage medium and/or as one or more computer-readable storage devices. In some implementations, the system memory 26 may include, be, or be part of temporary memory, meaning that a primary purpose of system memory 26 is not long-term storage. The system memory 26, in some implementations, may be described as a volatile memory, meaning that the system memory 26 does not maintain stored contents when the computer is turned off. Non-limiting examples of volatile memories include random access memories (RAM), dynamic random-access memories (DRAM), static random-access memories (SRAM), and other forms of volatile memories known in the art.

In some implementations, the system memory 26 may be used to store program instructions for execution by the processing circuitry 22. The system memory 26, in some implementations, may be used by logic, software, or applications implemented at the server device 12 to temporarily store information during program execution. The system memory 26, in some implementations, may include one or more computer-readable storage media. Non-limiting examples of such computer-readable storage media may include a non-transitory computer-readable storage medium, and various computer-readable storage devices. The system memory 26 may be configured to store larger amounts of information than volatile memory. The system memory 26 may further be configured for long-term storage of information. In some implementations, the system memory 26 may include non-volatile storage elements. Non-limiting examples of such non-volatile storage elements include magnetic hard discs, optical discs, floppy discs, flash memories, or forms of electrically programmable memories (EPROM) or electrically erasable and programmable (EEPROM) memories.

The autonomous vehicles 18 may represent vehicles configured to automate one or more tasks associated with vehicle operation. In implementations in which the autonomous vehicles 18 are capable of implementing level four or level five autonomy (also referred to as “full self-driving”), the autonomous vehicles 18 may be capable of automating most, if not all of the tasks associated with vehicle operation except for providing input related to destination selection. It will be appreciated that implementations autonomous vehicles 18 may be capable of automating various tasks, although not every vehicle of the autonomous vehicles 18 may implement automation of each function at all times. That is, in some instances, one or more of the autonomous vehicles 18 may disable the automation of certain tasks (e.g., based on a user input to instigate such a disabling of one or more operation tasks).

In general, the autonomous vehicles 18 may be assumed to be automobiles (cars). However, implementations may apply to any type of vehicle capable of conveying one or more occupants and operating autonomously, such as buses, recreational vehicles (RVs), semi-trailer trucks, tractors or other types of farm equipment, trains, motorcycles, airplanes, helicopters, unmanned aerial vehicles (UAVs or so-called “drones”), personal transport vehicles, various types of boats and ships, and so on. That is various implementations may be used with air-based vehicles (e.g., wing-based, rotor-based, etc.), land-based vehicles, water-based vehicles, or space-based vehicles.

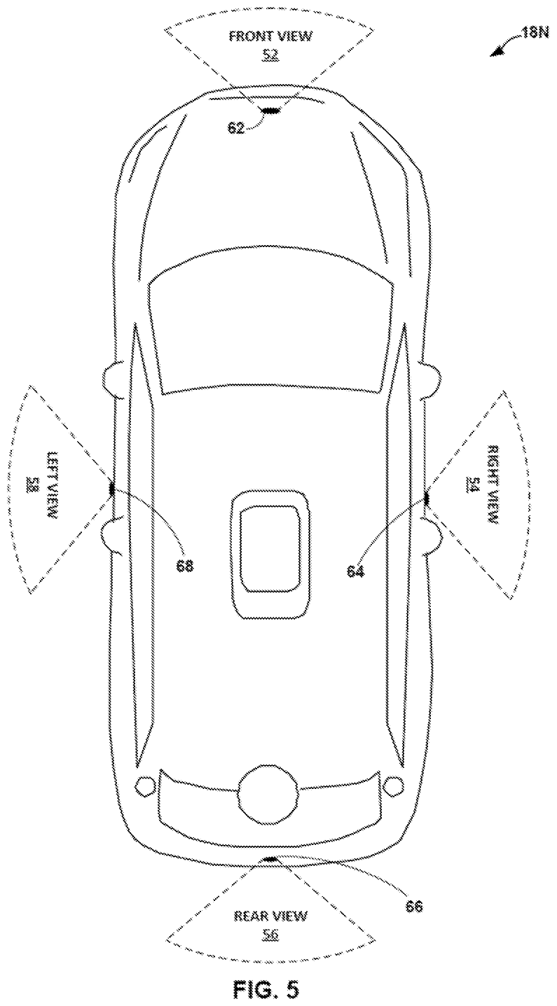

Each of the autonomous vehicles 18 may be equipped with communication logic and interface hardware (e.g., a communication unit, which is not shown for simplicity), by which each of each of the autonomous vehicles 18 may send and receive data over the wireless network 16. Each of the autonomous vehicles 18 may include sensor hardware (e.g., 62-68 in FIG. 5), which enables each of the autonomous vehicles 18 to determine conditions in the surroundings of the respective autonomous vehicle 18. It will be appreciated that not all of the autonomous vehicles 18 may have the same communication logic, interface hardware, and/or sensors. Further non-limiting details of the autonomous vehicles 18 configured according to vehicle-side implementations are described herein.

In various implementations, one or more of the autonomous vehicles 18 may track its own movement data and transmit or “upload” the movement data to the server device 12, via the wireless network 16. For instance, the communication unit 14 may receive data packets from one or more of the autonomous vehicles 18. The communication unit 14 may process (e.g., decapsulate) the data packets to obtain respective payload information of the data packets. In turn, the communication unit 14 may forward the payloads to the processing circuitry 22.

The processing circuitry 22 may implement further processing of the payload information of the data packets received from the autonomous vehicle(s) 18. For instance, the processing circuitry 22 may determine whether or not a particular payload is applicable to movement data that occurred within the traffic zone 20, or another traffic zone with respect to which the server device 12 is configured to generate pattern information. Additionally, the processing circuitry 22 may store portions of the processed payload data to the system memory 26. More specifically, the processing circuitry 22 may store the selected portions of the processed payloads to a buffer, such as movement data heuristics buffer 28, which may be implemented in the system memory 26.

In this way, the processing circuitry 22 of the server device 12 may implement various techniques to gather and store particular movement data that has occurred within the traffic zone 20. In turn, the processing circuitry 22 may leverage the movement data to formulate traffic pattern information, and to use the traffic pattern information to aid in navigation of vehicles that later enter the traffic zone 20. For instance, the processing circuitry 22 may extract, from the movement data heuristics buffer 28, past movement data with respect to the traffic zone 20. That is, the processing circuitry 22 may filter all available heuristics data using a zone identifier, GPS coordinates, or other identifier/metadata that associates certain movement data to the traffic zone 20.

In some implementations, the processing circuitry 22 may further filter the extracted movement data based on a time of occurrence (e.g., when the movement data was obtained or provided by the autonomous vehicle(s) 18). For instance, if certain movement data available from the movement data heuristics buffer 28 are associated with timestamps that are older than a predetermined ‘cutoff’ time, then processing circuitry 22 may discard such data for being ‘stale’ date. In further or alternative implementations, such movement data may decay over time. In such implementations, for example, the weight or reliability of the movement data is based on time.

In some implementations, the processing circuity 22 may filter (or otherwise reduce a weight of movement data based on any one or more factors, such (as but not limited to), reliability of the movement data source (e.g., a particular one of the autonomous vehicles 18 and/or a sensor thereof), a quality of the movement data (e.g., certain sensors may provide more reliable or trustworthy data), a type of movement data, weather conditions (e.g., temperature, humidity, precipitation levels, visibility, etc.), and/or the like.

Upon extracting data pertinent to the traffic zone 20 from the movement data heuristics buffer 28, the processing circuitry 22 may invoke pattern generation unit 24. The pattern generation unit 24 may be configured to perform various traffic pattern-based functionalities. In some implementations, the pattern generation unit 24 may use the extracted/filtered heuristic data to determine prevailing traffic conditions in the traffic zone 20 at the time the extracted data were generated by the autonomous vehicles 18. In some use case scenarios, the pattern generation unit 24 may use the determined traffic condition information to infer certain anomalies or abnormalities with respect to the state of the traffic zone 20. Non-limiting examples of such anomalies include traffic obstructions, lane closures, exit ramp backups, etc.

Based on any anomalies inferred with respect to the traffic zone 20, the pattern generation unit 24 may formulate a traffic pattern that is adapted to the prevailing traffic conditions at the traffic zone 20. More specifically, in some implementations, the pattern generation unit 24 may formulate a pattern that includes movement information, on a vehicle-by-vehicle basis, that improves traffic flow in view of the prevailing conditions at the traffic zone 20. That is, the pattern generation unit 24 may formulate a set of per-vehicle movements that, if implemented by those vehicles, assist the vehicles to better navigate the traffic zone 20 in view of any traffic flow impediments presented by the observed anomalies.

According to various implementations, the processing circuitry 22 may generate specific movement instructions, on a per-vehicle basis, with respect to the traffic zone 20. For instance, the processing circuitry 22 may generate movement instructions for a respective vehicle at respective positions within the traffic zone 20. That is, according to some implementations, the processing circuitry 22 may generate movement instructions that, if implemented by vehicles that subsequently travel through the traffic zone 20, result in a holistic and synergistic solution to one or more problems presented by the determined traffic conditions.

In turn, the processing circuitry 22 may transmit the movement instructions over the wireless network 16 to the autonomous vehicles 18 (an optionally to other vehicles configured to implement such instructions). In general, the movement instructions are generally described as being transmitted to the autonomous vehicles 18. It will be appreciated, however, that the set of autonomous vehicles 18 that uploaded the movement data from which pattern generation unit 24 generated the traffic pattern may differ, by at least one vehicle, from a set of autonomous vehicles 18 to which the processing circuitry 22 transmits the movement instructions. That is, the processing circuitry 22 uses the communication unit 14 to transmit the pattern-based movement instructions to a set of autonomous vehicles 18 that travel through the traffic zone 20 subsequently to another set of autonomous vehicles 18 having already traveled through traffic zone 20. The two sets of autonomous vehicles 18 may, but need not necessarily, have some degree of overlap.

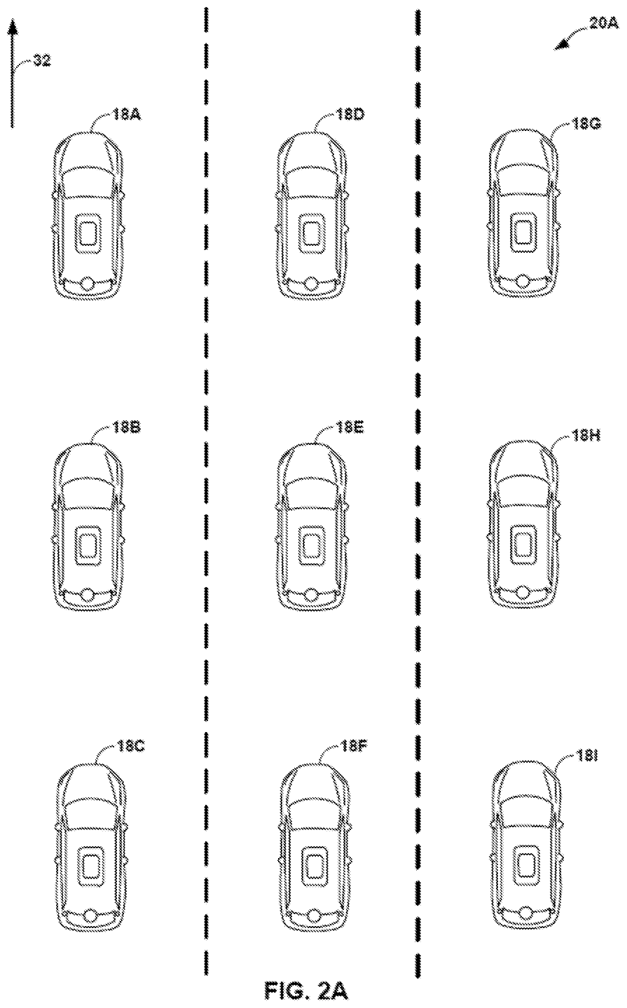

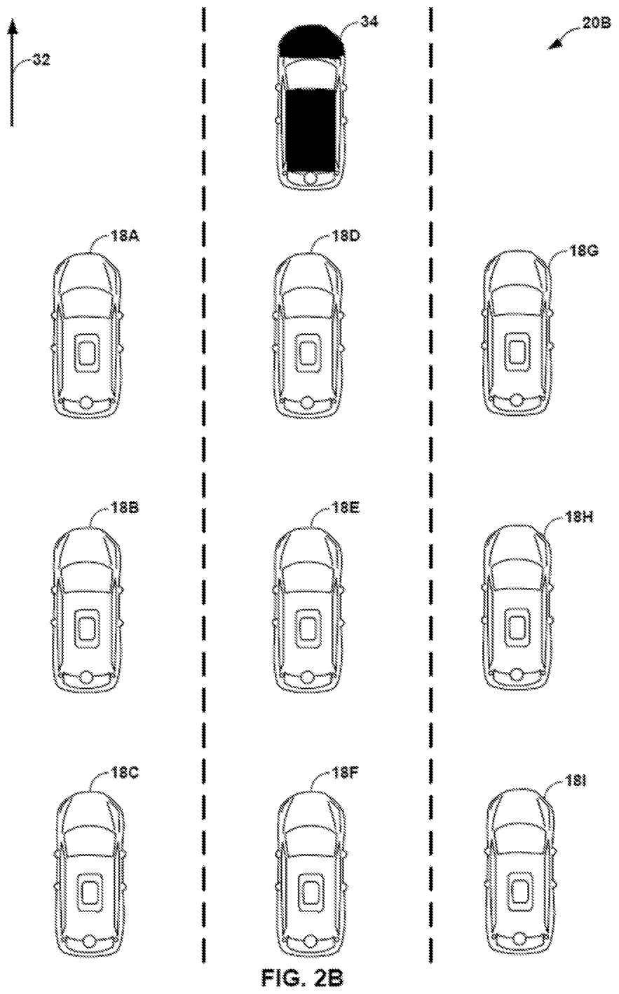

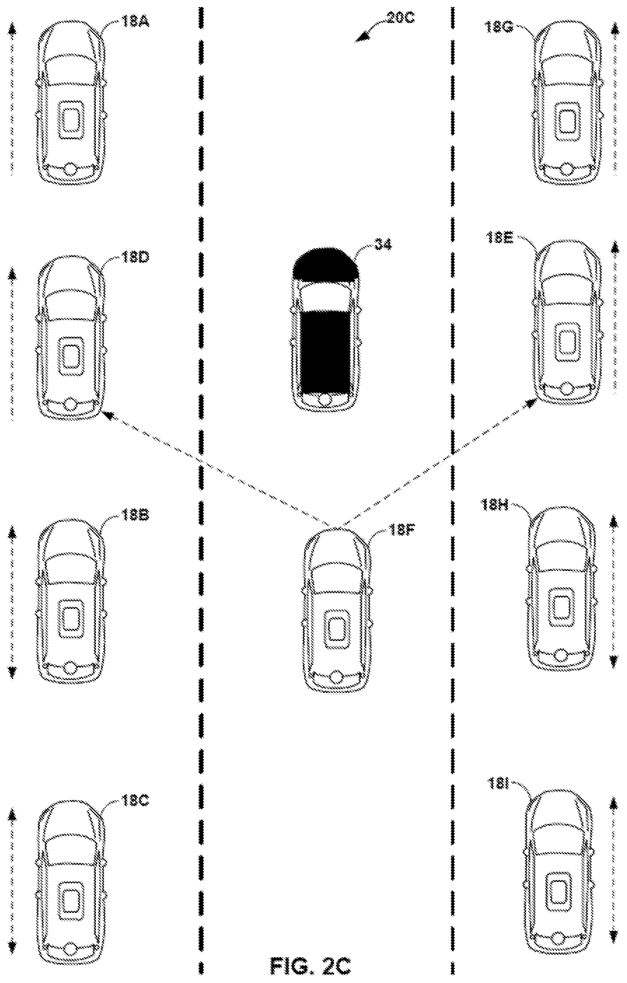

FIGS. 2A-2C are conceptual diagrams illustrating traffic conditions and vehicle operations in a traffic zone (e.g., 20 in FIG. 1) at various instances of time. FIG. 2A is a conceptual diagram illustrating traffic conditions in the traffic zone at a particular instant in time. The particular instance of the traffic zone 20 shown in FIG. 1 is represented in FIG. 2A as traffic zone 20A. With reference to FIGS. 1 and 2A, the traffic zone 20A may include nine vehicles (18A-18I) traveling in a single direction, through three lanes of a road. Direction 32 indicates the common direction of traffic flow of the traffic zone 20A. While the traffic zone 20A is illustrated as having a single, shared traffic flow direction (namely, the direction 32) as an example, it will be understood that various examples of the traffic zone 20A may include vehicles moving in multiple directions. Moreover, as an example, the traffic zone 20A is illustrated as including nine instances of autonomous vehicles 18. However, it will be understood that various examples of traffic zone 20 may include a variety of vehicles at any given time, such as manually operated vehicles, other types autonomous vehicles that are not represented by autonomous vehicles 18, or combinations thereof.

One or more of autonomous vehicles 18 (18A-18I) traveling through the traffic zone 20A may upload movement data over the wireless network 16 to the server device 12. For instance, the autonomous vehicle 18A may upload movement data pertaining to the autonomous vehicle 18A, the autonomous vehicle 18B may upload movement data pertaining to the autonomous vehicle 18B, and so on. For instance, the autonomous vehicles 18 may upload movement data that includes magnitude information (e.g., speed, expressed in distance per unit time) and directional information (e.g., a cardinal direction at varying levels of granularity) of the movement of the respective autonomous vehicle 18. The magnitude and directional implementations of the movement data may indicate various traffic events, such as lane change tendencies, the beginning or end of a bottleneck, etc. In general, the traffic zone 20A represents an example of normal, unimpeded traffic flow with respect to the autonomous vehicles 18.

FIG. 2B is a conceptual diagram illustrating traffic conditions in the traffic zone 20 (e.g., FIG. 1) at a different instant in time and is represented in FIG. 2B as traffic zone 20B. With reference to FIGS. 1-2B, similarly to the scenario illustrated for the traffic zone 20A, the traffic zone 20B may include nine of autonomous vehicles 18 (which may be at least partially different from the autonomous vehicles shown in the diagram of the traffic zone 20A), traveling along a common direction 32, in three lanes. In contrast to the scenario of the traffic zone 20A, the traffic zone 20B includes an obstruction 34. For example, the obstruction 34 may represent a stalled vehicle, which is shaded in to contrast the stalled vehicle from any of the autonomous vehicles 18.

The obstruction 34 is positioned in the middle lane of the traffic zone 20B, directly in front of autonomous vehicle 18D. The autonomous vehicle 18D, in turn, is positioned directly in front of autonomous vehicle 18E, which is positioned directly in front of autonomous vehicle 18F. As such, the obstruction 34 represents a traffic impediment, whether directly or transitively, with respect to autonomous vehicles 18D-18F. Thus, at the instant in time represented for the traffic zone 20B, the autonomous vehicles 18D-18F may upload movement data that indicate a slowdown or eventually, a stoppage of movement along the direction 32. In some implementations, in contrast, the autonomous vehicles 18A-18C and the autonomous vehicles 18G-18I may upload movement data that indicate unimpeded movement along the direction 32.

Based on the movement data received from the autonomous vehicles 18D-18F, the pattern generation unit 24 may infer the presence(s) of a traffic impediment in the traffic zone 20B. For instance, the pattern generation unit 24 may determine that traffic movement in the middle lane of the traffic zone 20B is impeded, based on the movement data (e.g., speed information) uploaded by the autonomous vehicles 18D-18F, and based on location/position (e.g., GPS) coordinates of the autonomous vehicles 18D-18F, which indicate that the autonomous vehicles 18D-18F are traveling in the middle lane of the traffic zone 20B. In some implementations, the pattern generation unit 24 additionally may determine that the leftmost lane and the rightmost lane of the traffic zone 20B are free from traffic impediments, based on the speed and directional information reflected in the movement data uploaded by the autonomous vehicles 18A-18C and the autonomous vehicles 18G-18I. In this way, the pattern generation unit 24 may use the movement data uploaded by the autonomous vehicles 18 while traveling through the traffic zone 20B to determine that traffic flow is impeded in the middle lane of the traffic zone 20B, but that traffic flow is unimpeded in the leftmost and rightmost lanes of the traffic zone 20B.

FIG. 2C is a conceptual diagram illustrating traffic conditions in traffic zone 20 (e.g., FIG. 1) at yet another instant in time and is represented in FIG. 2C as traffic zone 20C. With reference to FIGS. 1-2C, the traffic zone 20C represents traffic conditions at traffic zone 20 at some time subsequently to the conditions reflected in the traffic zone 20B. At the time of occurrence of the traffic conditions shown for the traffic zone 20C, the autonomous vehicles 18A and 18G have moved forward in the leftmost and rightmost lanes, respectively, of the traffic zone 20C. That is, the autonomous vehicles 18A and 18G have moved ahead of positions that are parallel with the obstruction 34 in the middle lane of traffic zone 20C.

Additionally, the instant in time represented by the traffic zone 20C reflects a scenario in which the autonomous vehicles 18D and 18E, which were previously traveling through the middle lane and impeded by the obstruction 34, have now changed lanes. In the specific example of the instant in time represented by the traffic zone 20C, the autonomous vehicle 18D has merged into the leftmost lane of the traffic zone 20C, and the autonomous vehicle 18E has merged into the rightmost lane of the traffic zone 20C. More specifically, the instant in time represented by the traffic zone 20C illustrates a scenario in which the autonomous vehicle 18D has moved into a position between the autonomous vehicles 18A and 18B, and in which the autonomous vehicle 18E has moved into a position between the autonomous vehicles 18G and 18H. Stated more generally, the traffic zone 20C represents a scenario in which the autonomous vehicles 18D and 18E have already navigated a path around the traffic flow impediment presented by the obstruction 34. However, at the instant in time represented by the traffic zone 20C, the forward movement of the autonomous vehicle 18F is still impeded by obstruction 34.

In the instant in time represented by the traffic zone 20C, each of the autonomous vehicles 18 is illustrated with one or more directional arrows, to indicate a respective intended direction of movement. As shown, each of the autonomous vehicles 18A, 18D, 18G, and 18E has an intended ‘forward’ direction of movement. That is, each of the autonomous vehicles 18A, 18D, 18G, and 18E is not (or is no longer) impeded with respect to forward movement, because each of the autonomous vehicles 18A, 18D, 18G, and 18E is positioned in a lane that does not include the obstruction 34. Moreover, each of the autonomous vehicles 18A, 18D, 18G, and 18E is positioned “latitudinally” ahead of the obstruction 34, meaning that none of the autonomous vehicles 18A, 18D, 18G, and 18E is in a position to accommodate vehicles merging from the obstructed middle lane.

Each of the autonomous vehicles 18B and 18H is illustrated with a combination forward/backward arrow. The combination forward/backward arrows indicate that each of autonomous vehicles 18B and 18H may continue forward movement, may reverse, or may remain stationary for some period of time. More specifically, each of autonomous vehicles 18B and 18H is in an unobstructed lane but is in a position from which each of the autonomous vehicles 18B and 18H can accommodate a merging vehicle from the obstructed middle lane of the traffic zone 20C. As an example for discussion, each of the autonomous vehicles 18B and 18H may be described as being stationary in the context of the traffic zone 20C. That is, each of the autonomous vehicles 18B and 18H has come to a temporary stop, in order to allow the autonomous vehicle 18F to merge into the respective unobstructed lane.

In turn, the autonomous vehicle 18F may select one of the leftmost lane or the rightmost lane of the traffic zone 20C as a lane-change destination. The autonomous vehicle 18F is illustrated (in FIG. 2C) with two diagonal forward arrows, each directed to a respective unobstructed lane of the traffic zone 20C. The autonomous vehicle 18F is illustrated in this manner to indicate that the autonomous vehicle 18F is configured to select between the two neighboring unobstructed lanes for the lane-change movement. The autonomous vehicle 18F may be equipped with sensor hardware and logic circuitry that enable autonomous vehicle 18F to detect and analyze proximity, speed, and directional information associated with the motion of the remaining autonomous vehicles 18. Using the sensed information with respect to the remaining autonomous vehicles 18, the autonomous vehicle 18F may select one of the neighboring unobstructed lanes into which to merge. In some implementations, the autonomous vehicle 18F may be equipped with inter-vehicle communication capabilities (either directly or indirectly via an intermediary device, such a server or the like), which enable autonomous vehicle 18F to provide information to the autonomous vehicle 18B, the autonomous vehicle 18H, or other autonomous vehicles 18, of the impending lane-change.

One or more of autonomous vehicles 18 may, in accordance with implementations of this disclosure, upload respective movement information to the server device 12, over the wireless network 16. As examples, the autonomous vehicles 18A, 18D, 18G, and 18E may upload data indicating their respective unimpeded forward movements through the traffic zone 20C. Additionally, the autonomous vehicles 18B and 18H may upload data indicating their temporary stoppage (or very low speed, e.g., 1-2 MPH) and the coordinates of their stop locations. The autonomous vehicle 18F may upload data indicating its stoppage behind the obstruction 34, and in some examples, may also upload portions of the lane-change criteria being analyzed.

As discussed, the processing circuitry 22 of the server device 12 may store the movement data received from the autonomous vehicles 18 to the movement data heuristics buffer 28. In turn, the pattern generation unit 24 may analyze the subset of data stored in the movement data heuristics buffer 28 that applies to the time frame of the traffic zone 20C. More specifically, the pattern generation unit 24 may analyze the movement data for the traffic zone 20C to determine traffic pattern information. In turn, the pattern generation unit 24 may use the traffic pattern determined from the conditions of the traffic zone 20C to determine movements for individual vehicles that travel through traffic zone 20 at a subsequent time to the occurrence of the conditions of the traffic zone 20C.

In this example, the pattern generation unit 24 may use several data points extracted from the movement data heuristics buffer 28 to determine the existence and approximate location of the obstruction 34. For instance, the pattern generation unit 24 may use movement data indicating the latitude (or other location/position information) at which the autonomous vehicle 18D transitioned from the middle lane to the leftmost lane to determine the presence and approximate location of the obstruction 34. In addition, or alternatively, the pattern generation unit 24 may use movement data indicating the latitude at which the autonomous vehicle 18E transitioned from the middle lane to the rightmost lane to determine the presence and approximate location of the obstruction 34. In addition, or alternatively, the pattern generation unit 24 may use movement data indicating the slowdown and/or eventual stoppage (and latitude thereof) of the autonomous vehicle 18F to determine the presence and approximate location of the obstruction 34.

In turn, the pattern generation unit 24 may generate movement instructions for a set of vehicles that could potentially travel through the traffic zone 20 at a time subsequent to the time of the occurrence of the conditions of the traffic zone 20C. As one implementation of pattern-driven instruction generation with respect to the traffic zone 20C, the pattern generation unit 24 may generate lane-change instructions for vehicles in the middle lane of the traffic zone 20 subsequently to autonomous vehicles 18 being positioned in the traffic zone 20C. In various implementations, the pattern generation unit 24 may generate the lane-change instructions with respect to locations that are at various distances from the inferred/estimated location of the obstruction 34. For example, the pattern generation unit 24 may generate the lane-change instructions at a greater distance from the obstruction 34 to alleviate lane-change wait times for the vehicles in the middle lane, or the pattern generation unit 24 may generate the lane-change instructions at a shorter distance from the obstruction 34 to allow for freer-flowing traffic in the unobstructed lanes until a lane change is necessary for an impeded vehicle in the middle lane.

In some such examples, the pattern generation unit 24 may also generate movement instructions for vehicles traveling in the unobstructed lanes of the traffic zone 20, in order to accommodate incoming merging by vehicles exiting the middle lane. For instance, the pattern generation unit 24 may generate instructions for vehicles that subsequently occupy the position or approximate position of the autonomous vehicle 18B (as shown in FIG. 2C) to slow down or temporarily stop. The slow down/stop instruction that the pattern generation unit 24 generates in this example is aimed at accommodating the incoming merge of a vehicle that is in the middle lane and attempting to navigate around the obstruction 34.

As described, the pattern generation unit 24 may crowdsource and leverage movement and location data uploaded by the autonomous vehicles 18 from the traffic zone 20C to generate movement instructions for vehicles that subsequently travel through the same geographic area (traffic zone 20). More specifically, the pattern generation unit 24 may use the received movement data to generate instructions that enable a subsequent set of vehicles to synergistically compensate for the traffic impediment caused by the obstruction 34. In this way, the pattern generation unit 24 may implement the techniques of this disclosure to improve traffic flow in a given traffic zone (or geographic area) using movement data gathered from one or more sets of vehicles that previously traveled through the traffic zone.

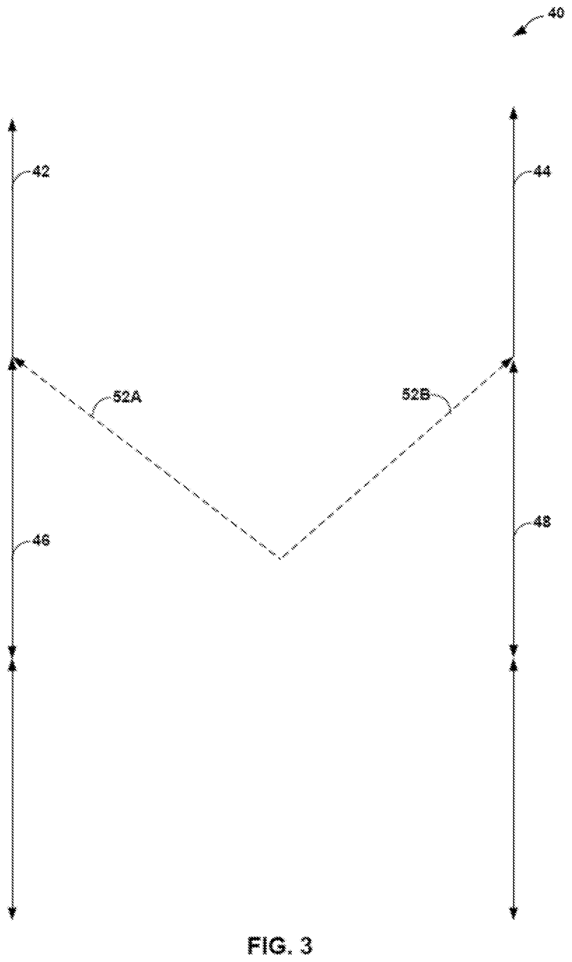

FIG. 3 is a conceptual diagram illustrating a pattern-based instruction set 40 that a pattern generation unit (e.g., 24 in FIG. 1) may generate, based on movement data gathered from autonomous vehicles 18 when positioned as shown in FIG. 2C. For ease of discussion, pattern-based instruction set 40 is hereinafter referred to as “pattern 40.” With reference to FIGS. 1-3, the pattern 40 comprises a combination of movement instructions that the server device 12 may communicate to a set of vehicles that travel through the traffic zone 20 at some instance of time that is subsequent to the time of occurrence of the conditions represented by traffic zone 20C.

The pattern generation unit 24 may generate the pattern 40 to include forward movement instructions 42 and 44. More specifically, the pattern generation unit 24 generates the forward movement instructions 42 and 44 to be conveyed to vehicles that are co-located or substantially co-located with the autonomous vehicles 18A and 18G (in FIG. 2C). That is, the forward movement instructions 42 and 44 correspond to vehicles that are in unobstructed lanes of the traffic zone 20 and are latitudinally ahead of the obstruction 34.

Additionally, the pattern generation unit 24 may generate the pattern 40 to include stoppage instructions 46 and 48. The stoppage instructions 46 and 48 are related to vehicle stoppage in the specific example of FIG. 3 and may, in other examples, represent a slowed-down forward movement instruction, a reverse instruction, or other type of instruction. Again referring to FIGS. 1-3, the pattern generation unit 24 may generate the stoppage instructions 46 and 48 to be conveyed to vehicles that are co-located or substantially co-located with the autonomous vehicles 18B and 18H (in FIG. 2C). That is, the stoppage instructions 46 and 48 correspond to vehicles that are in unobstructed lanes of the traffic zone 20, but which are latitudinally parallel or substantially parallel to the obstruction 34. As such, the pattern generation unit 24 may generate the stoppage instructions 46 and 48 with respect to vehicles that are positioned in such a way that they can accommodate possible incoming lane merges from vehicles that exit the obstructed/impeded middle lane of the traffic zone 20. The pattern 40 may include stoppage instructions (not called out for purposes of brevity) to be conveyed to vehicles positioned behind the vehicles receiving the stoppage instructions 46 and 48.

In some implementations, the pattern 40 may include optional lane-change instructions 52A and 52B. For instance, the pattern generation unit 24 may generate the lane-change instructions 52A and 52B to represent alternative movements for a single vehicle. The optional nature of the lane-change instructions 52A and 52B is illustrated using dashed lines. That is, the pattern generation unit 24 may generate the lane-change instructions 52A and 52B as alternative options that a vehicle may use, to navigate the last-compiled traffic conditions pertinent to the traffic zone 20. For instance, the pattern generation unit 24 may generate the lane-change instructions 52A and 52B to be conveyed to a vehicle that is co-located or substantially co-located with the autonomous vehicle 18F (in FIG. 2C). More specifically, the lane-change instructions 52A and 52B may represent two possible courses of action that a vehicle may implement to navigate around the obstruction 34.

In various implementations, the pattern generation unit 24 may provide both of lane-change instructions 52A and 52B to a vehicle and permit the receiving vehicle to select between the lane-change instructions 52A and 52B. For instance, the vehicle that receives the lane-change instructions 52A and 52B may select between the two presented options, based on sensory data indicating the speed, position, direction, or other movement-related data associated with each of the vehicles that the received stoppage instructions 46 and 48. Based on which one of the neighboring unobstructed lanes presents a more viable option into which to merge, the vehicle receiving the lane-change instructions 52A and 52B may select between the lane-change instructions 52A and 52B for implementation.

In various implementations, the vehicle that receives the lane-change instructions 52A and 52B may be agnostic to specific characteristics of the obstruction 34. Instead, the pattern generation unit 24 may generate the lane-change instructions 52A and 52B based on movement-related heuristics gathered from the autonomous vehicles 18, and as such, conveys movement-related instructions to the vehicle that receives the lane-change instructions 52A and 52B. In this way, the pattern generation unit 24 conveys movement instructions that enable a subsequent set of vehicles to synergistically navigate around an obstruction or other traffic impediment, without expending resources or bandwidth that would might otherwise be consumed to convey the nature of the obstruction/traffic impediment.

In various implementations, each of the forward movement instructions 42 and 44, stoppage instructions 46 and 48, and lane-change instructions 52A and 52B (collectively, “instructions 42-52”) may represent a vector. That is, the pattern generation unit 24 generates the pattern 40 such that each of instructions 42-52 includes a respective directional component and a respective magnitude component. For instance, each of the instructions 42-52 may represent a velocity vector. Thus, each of the instructions 42-52 may include a speed value as its respective magnitude component, in addition to a direction in which the respective vehicle is to travel at the instructed speed. For instance, each of the stoppage instructions 46 and 48 represents a decrease in speed, which the receiving vehicles may implement in order to accommodate an incoming lane merge. The projected position of each receiving vehicle may be considered a ‘node’ in the pattern 40 in that the projected position of each receiving vehicle is at the origination point of a respective vector.

The pattern generation unit 24 may implement one or more pattern recognition techniques and/or machine learning algorithms to dynamically generate the set of movement instructions that make up the pattern 40. For instance, pattern recognition aspects of the techniques correspond to operations by which the pattern generation unit 24 matches data extracted from the movement data heuristics buffer 28 against predetermined or previously-formulated traffic patterns. Machine learning aspects of the techniques may include operations by which the pattern generation unit 24 updates various pattern generation methodologies (including, but not limited to, pattern recognition operations) that are to be implemented for formulation of future traffic patterns.

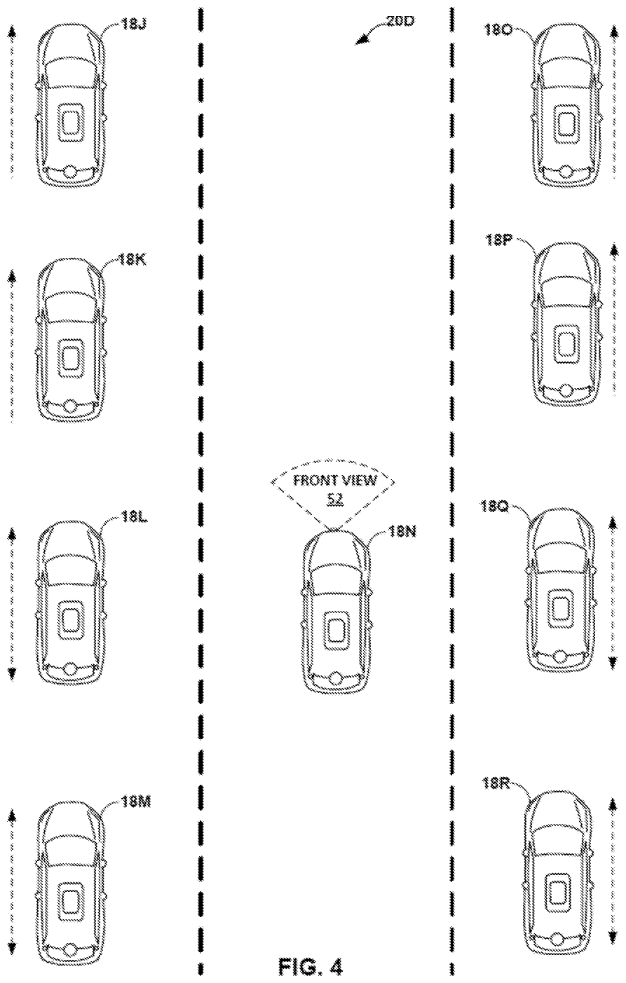

FIG. 4 is a conceptual diagram illustrating traffic pattern validity checking according to various implementations. FIG. 4 illustrates traffic conditions at the traffic zone 20 at an instance of time that occurs subsequently to the conditions illustrated in FIG. 2C. More specifically, traffic zone 20D of FIG. 4 illustrates the conditions at the traffic zone 20 at a time when a subsequent set of vehicles (autonomous vehicles 18J-18R, which may also be referred to collectively, in whole or in part, as autonomous vehicles 18) are traveling through the traffic zone 20. As shown in FIG. 4, an obstruction (e.g., obstruction 34 in FIG. 2C) is not present in the middle lane of the traffic zone 20D. That is, the obstruction 34 has been removed from the traffic zone 20 during the time that elapsed between the conditions of the traffic zone 20C (FIG. 2C) and the conditions of the traffic zone 20D.

With reference to FIGS. 1-4, however, based on the previously-generated traffic pattern information (namely, the pattern 40) for the traffic zone 20, the processing circuitry 22 may transmit movement instructions to the autonomous vehicles 18J-18R that are based on the now-invalid presence and location of the obstruction 34. For instance, the autonomous vehicles 18L, 18M, 18Q, and 18R may be subject to stoppage instructions based on their locations relative to the previously-inferred approximate location of the obstruction 34. Moreover, the processing circuitry 22 may transmit one or more of the alternative lane-change instructions 52A or 52B to the autonomous vehicle 18N based on the previously-inferred approximate location of obstruction 34 and/or based on the autonomous vehicle 18N traveling in the middle lane of the traffic zone 20D. Lane-change instructions 52A and 52B are not shown for the traffic zone 20D purely for simplicity.

One or more of the autonomous vehicles 18J-18R may be configured to use sensory input data to verify or to disprove the current validity of pattern-based movement instructions received from the server device 12. In the example of the traffic zone 20D, the autonomous vehicle 18N represents an example of a vehicle configured to implement such functionalities. For instance, the autonomous vehicle 18N may be equipped with various types of sensors including, but not limited to, one or more of camera hardware, light detection and ranging (LiDAR) hardware, radio detection and ranging (RADAR) hardware, ultrasonic sensor hardware, sound navigation and ranging (SONAR) hardware, or others. Processing circuitry of the autonomous vehicle 18N may determine whether or not an obstruction is present, and if so, a distance between the autonomous vehicle 18N and the obstruction.

In the example of the traffic zone 20D, the autonomous vehicle 18N (e.g., by way of processing circuitry) may use sensory input data to analyze the conditions surrounding the physical bounds of the overall structure of the autonomous vehicle 18N. For instance, the autonomous vehicle 18N may analyze or otherwise process data received from a focal range of front-facing sensor hardware to form front view 52. Using the sensory input data reflecting conditions in the front view 52, the autonomous vehicle 18N may determine that at least the immediately preceding portion of the middle lane of the traffic zone 20D is unobstructed. Additionally or alternatively, the autonomous vehicle 18N may implement vehicle-side implementations of this disclosure to determine that either of lane-change instructions 52A or 52B represents a now-unnecessary operation. More specifically, the autonomous vehicle 18N may determine, based on the middle lane of the traffic zone 20D being unobstructed in the focal range of the front view 52, that the middle lane of the traffic zone 20D provides a more efficient path forward than a lane-change.

Using one or more pattern validity-checking functionalities of this disclosure, the autonomous vehicle 18N may determine that the pattern 40, or certain aspects thereof, are invalid or obsolete with respect to the current conditions in the traffic zone 20. As discussed, in the specific example of the traffic zone 20D, the autonomous vehicle 18N determines that a lane change is no longer necessary, in contradiction to the lane-change instructions 52A and 52B transmitted by the server device 12. As such, the autonomous vehicle 18N determines that aspects of the pattern 40 are invalid to the extent that vehicles need not move out of the middle lane, and consequently, that vehicles in the leftmost and rightmost lanes need not alter their speeds to accommodate incoming lane merges from the middle lane.

The autonomous vehicle 18N may implement one or more vehicle-side techniques to upload pattern-validity information to the server device 12. For instance, upon analyzing the traffic zone 20D using the sensory input data from the front view 52, the autonomous vehicle 18N may upload an indication that the pattern 40 (or a portion thereof) is no longer valid. In some coarse-grained implementations of the techniques of this disclosure, the autonomous vehicle 18N may upload an indication that the currently-used pattern (the pattern 40 in this example), in general, is invalid, based on certain instructions no longer being applicable to the conditions at the traffic zone 20D. In some (more) fine-grained or granular implementations, the autonomous vehicle 18N may upload an indication of specific portions of the pattern 40 that are now invalid.

In some implementations, based on receiving such a pattern invalidity indication from the autonomous vehicle 18N or any other vehicle, the pattern generation unit 24 may discard pattern 40 as the basis of movement instructions to be transmitted to the autonomous vehicles 18 in the traffic zone 20. For instance, the pattern generation unit 24 may use more up-to-date information available from the movement data heuristics buffer 28 to generate a new pattern. In some implementations, in the intervening time between the discarding of the pattern 40 and the formulation of a new pattern, the pattern generation unit 24 may not transmit further movement instructions to the autonomous vehicles 18 in or near the traffic zone 20. Instead, during this intermediate period, the pattern generation unit 24, for example, may allow autonomous vehicles 18 to navigate traffic zone 20 using locally-implemented navigation technology.

In some implementations, based on receiving such a pattern invalidity indication from the autonomous vehicle 18N or any other vehicle, the server device 12 (e.g., processing circuitry 22) may determine whether to trust or otherwise act on the received pattern invalidity indication. For instance, the received pattern invalidity indication may be compared to an autonomous vehicle providing its own pattern invalidity indication.

FIG. 5 is a conceptual diagram illustrating an aerial view of the autonomous vehicle 18N. Although various vehicles described in this disclosure may include some or all of the components illustrated in FIG. 5 and may implement some or all of the functionalities described with respect to FIG. 5, the autonomous vehicle 18N is used as a non-limiting example. With reference to FIGS. 1-5, the autonomous vehicle 18N may be configured to receive sensory input data with respect to the physical area indicated by the front view 52. For instance, the autonomous vehicle 18N may receive the data for the front view 52 using front-facing sensor hardware 62. Additionally, the autonomous vehicle 18N may receive sensory input data for right view 54 using right-facing sensor hardware 64, for rear view 56 using rear-facing sensor hardware 66, and for left view 58 using left-facing sensor hardware 68. Each of the front-facing sensor hardware 62, right-facing sensor hardware 64, rear-facing sensor hardware 66, and left-facing sensor hardware 68 may represent (but is not limited to) one or more of camera hardware, light detection and ranging (LiDAR) hardware, radio detection and ranging (RADAR) hardware, ultrasonic sensor hardware, sound navigation and ranging (SONAR) hardware, or any combination thereof, or other types of sensor hardware.

Processing circuitry of the autonomous vehicle 18N may analyze sensory input data from one or more of the front view 52, right view 54, rear view 56, or left view 58 for a variety of purposes. As one example, the processing circuitry of the autonomous vehicle 18N may analyze the sensory input data to locally formulate navigation operations, such as lane changes, speed changes, stoppages, etc. As another example, the processing circuitry of the autonomous vehicle 18N may implement vehicle-side techniques of this disclosure to analyze the sensory data to determine whether certain movement instructions received from the server device 12 are still viable or have become obsolete.

If the processing circuitry of the autonomous vehicle 18N determines, from the analyzed sensory input data, that movement instructions received from the server device 12 has become obsolete (or is otherwise not relevant or useful), then the processing circuitry of the autonomous vehicle 18N may upload an indication of an invalid pattern to the server device 12. It will be appreciated that, as used herein, an “indication of invalid pattern” may encompass communications that indicate that a pattern, in general, is invalid, or that certain specific portions (e.g., particular movement instructions) of the pattern are invalid. Thus, the autonomous vehicle 18N may implement various vehicle-side aspects of the techniques of this disclosure to provide crowdsourced traffic data, and to assist in the updating of pattern information. In this way, the autonomous vehicle 18N may assist in improving traffic flow to suit the prevalent conditions in the traffic zone 20.

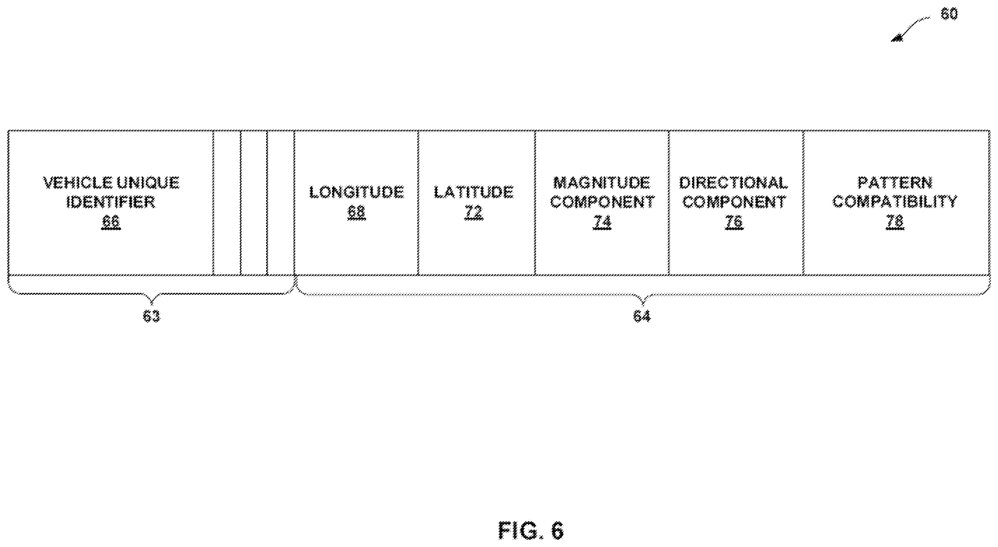

FIG. 6 is a conceptual diagram illustrating structural implementations of an example pattern packet 60 that one or more of autonomous vehicles (e.g., 18 in FIGS. 1-5) may upload to a server device (e.g., 12 in FIG. 1), in accordance with various implementations. It will be appreciated that FIG. 6 illustrates a subset of the fields included in the pattern packet 60, for ease of illustration and discussion. With reference to FIGS. 1-6, any of the autonomous vehicles 18, or even a manually-operated vehicle, may generate and upload the pattern packet 60 (or portions thereof) to assist the server device 12 in populating of the movement data heuristics buffer 28.

The pattern packet 60 generally includes two portions, namely, a header 63 and a payload 64. The header 63 may include various fields, such as a vehicle unique identifier 66. As shown (e.g., in FIG. 6), the header 63 may include additional fields, but are not called out for ease of illustration and for brevity of discussion. The vehicle unique identifier 66 may include identification data that is unique to the vehicle that generated and uploaded the pattern packet 60. As such, the vehicle unique identifier 66 serves as a source-identification portion of the pattern packet 60.

The payload 64 of the pattern packet 60 may include various fields, including longitude 68 and latitude 72 (or other position/location information), magnitude component 74, directional component 76, and pattern compatibility 78. Again, the payload 64 may include additional fields, which are not shown for ease of illustration and for brevity of discussion. The longitude 68 and latitude 72 (or the like) may be one or more field(s) that include data indicating position/location coordinates of the vehicle at the time of generating the pattern packet 60. The magnitude component 74 may be a field that includes data indicating the speed at which the vehicle was traveling at the time of generating the pattern packet 60. As discussed, speed information forms the magnitude component of a velocity vector. The directional component 76 may be a field that provides the direction in which the vehicle was traveling at the time of generating the pattern packet 60. As such, the component 76, in combination with the magnitude component 74, completes the velocity vector information conveyed by the vehicle that uploads the pattern packet 60.

The pattern compatibility 78 may indicate the generating vehicle's compatibility with respect to the receipt and/or implementation of pattern-based movement instructions that the server device 12 may transmit. For instance, some vehicles (e.g., lower-degree autonomous vehicles or manually-operated vehicles) may be configured to generate and upload the pattern packet 60 but may not be configured to implement movement instructions received from the server device 12. Or for instance, some vehicles may be configured to generate and upload only a portion or subset of the pattern packet 60 (e.g., because such vehicles lack the appropriate equipment, some of the equipment may be malfunctioning or operational, etc.). Thus, the pattern packet 60 represents a communication that a variety of vehicles may generate to assist in crowdsourcing of traffic data, regardless of whether or not the generating vehicle is configured to later avail of the resulting pattern-based movement instructions.

It should also be appreciated that the pattern packet 60 is described as including a plurality of discrete fields each having a value. However, it should be noted that in some implementations, fields may be consolidated. For instance, the magnitude component 74 and the directional component 76 may be consolidated into a single field with both values for providing velocity vector information. Or for instance, the longitude 68 and the latitude 72 may be provided as a coordinate in a single position/location field.

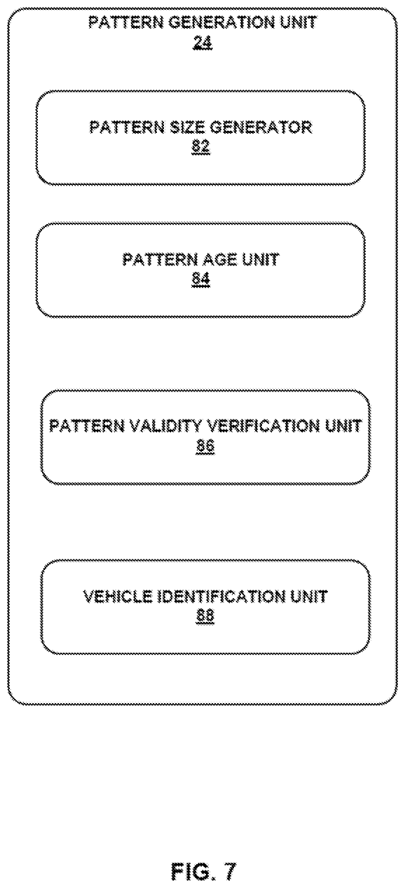

FIG. 7 is a block diagram illustrating an example implementation of the pattern generation unit 24 (FIG. 1). With reference to FIGS. 1-7, the pattern generation unit 24 may be or be part of the processing circuitry 22. The pattern generation unit 24 may be formed in one or more microprocessors, application specific integrated circuits (ASICs), field programmable gate arrays (FPGAs), digital signal processors (DSPs), processing circuitry (including fixed function circuitry and/or programmable processing circuitry), or other equivalent integrated logic circuitry or discrete logic circuitry. In some implementations, the pattern generation unit 24 may include (but is not limited to) a pattern size generator 82, a pattern age unit 84, a pattern validity verification unit 86, and a vehicle identification unit 88. It will be appreciated that in various examples, pattern generation unit 24 may include additional components, exclude some of the components, and/or may implement two or more of the illustrated components as a single consolidated component.

To generate a traffic pattern for a traffic zone (e.g., 20) using data extracted from the movement data heuristics buffer 28, the pattern generation unit 24 may invoke the pattern size generator 82. The pattern size generator 82 may be configured to determine a number of vehicles to be represented in a traffic pattern (e.g., pattern 40). The pattern size generator 82 may use various criteria to determine the size (which may be expressed in terms of a number of vehicles or area/volume occupied by vehicles) of the pattern 40. As one non-limiting example, the pattern size generator 82 may use a number of vehicles that generated the portion of the extracted movement heuristics that are used for generating the pattern 40. That is, in this example, the pattern size generator 82 may determine that the pattern generation unit 24 has extracted movement data uploaded by nine vehicles for generating the pattern 40, and thus, that the pattern 40 will correspond to a nine-vehicle scenario. In other words, in this example, the pattern size generator 82 determines a nine-vehicle size for the pattern 40. In other examples, the pattern size generator 82 may use other criteria in determining the size of the traffic pattern, such as a geographic (and/or volumetric) area covered by the extracted movement heuristics, etc.

In some implementations, the pattern generation unit 24 may invoke the pattern age unit 84 before causing the communication unit 14 to transmit the movement instruction set represented in the pattern 40. The pattern age unit 84 may be configured to determine a length of time elapsed between the original generation of the pattern 40 and the current time (or between a last updated generation of the pattern 40 and the current time). That is, the pattern age unit 84 may assist the pattern size generator 82 in gauging whether or not the pattern 40 has become “stale.” In some examples where the pattern age unit 84 returns an age value that the pattern generation unit 24 determines not to be associated with a stale pattern, the pattern generation unit 24 may proceed with the transmission of the pattern 40 (via the communication unit 14) without any further checking. In other words, if the pattern age unit 84 returns an age value that is below a certain threshold, then the pattern generation unit 24 determines that the pattern 40 is, by definition, current and valid for the traffic zone 20.

In contrast, if the pattern age unit 84 returns an age value that meets or exceeds the threshold age, then the pattern generation unit 24 may perform further validity checking to determine whether or not the pattern 40 is current and valid for the prevailing conditions at the traffic zone 20. For instance, the pattern generation unit 24 may invoke the vehicle identification unit 88 to identify any vehicles with pattern validity-checking authorization that have traveled through the traffic zone 20. If the vehicle identification unit 88 returns identities of one or more vehicles with pattern validity-checking authorization that have traveled through the traffic zone 20, then the pattern generation unit 24 may access any pattern validity information that has been uploaded by any validity-checking authorized vehicles.

For instance, the pattern generation unit 24 may determine whether any pattern-validity information with respect to the pattern 40 is currently stored to the system memory 26. If the pattern generation unit 24 locates any pattern-validity information for the pattern 40 in the system memory 26, then the pattern generation unit 24 may invoke the pattern validity verification unit 86 to perform further processing. For instance, the pattern validity verification unit 86 may determine whether the pattern validity information indicates that the pattern 40 is currently invalid with respect to the conditions at the traffic zone 20. In some implementations, first the pattern validity verification unit 86 may determine whether the pattern-validity information includes any invalidity indications of the pattern 40. Then, the pattern validity verification unit 86 may determine the generation time (e.g., from a timestamp) of any detected invalidity indication. If the pattern validity verification unit 86 determines that such an invalidity indication was generated relatively recently (e.g., within a threshold length of time preceding the check time), then the pattern validity verification unit 86 may determine that the pattern 40 is now invalid with respect to the current conditions at the traffic zone 20.

In turn, if the pattern validity verification unit 86 returns an invalidity finding with respect to the pattern 40, then the pattern generation unit 24 may scrap the use of pattern 40 (or a portion thereof). For instance, the pattern generation unit 24 may cease transmission of one or more movement instructions of the pattern 40 to the autonomous vehicles 18. During any time period in which the pattern generation unit 24 does not transmit pattern-based movement instructions to the autonomous vehicles 18, the autonomous vehicles 18 may navigate traffic zone 20 using locally-implemented logic. In turn, the pattern generation unit 24 may mine the movement data heuristics buffer 28 for data that enables the pattern generation unit 24 to generate a new pattern for the traffic zone 20, based on more recently-reported traffic conditions.

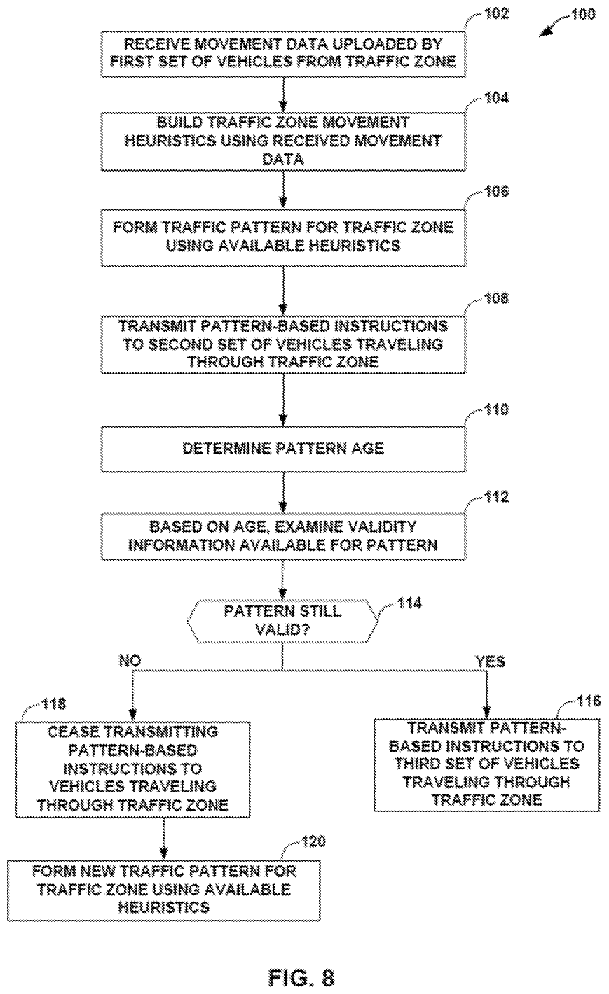

FIG. 8 is a flowchart illustrating an example process 100 that server device 12 (FIG. 1) and/or components thereof may perform to implement various server-side implementations of the techniques described herein. With reference to FIGS. 1-8, process 100 may begin when the server device 12 uses the communication unit 14 to receive movement data uploaded by a first set (e.g., subset) of autonomous vehicles 18 via the wireless network 16 (block 102). In turn, the processing circuitry 22 may use the system memory 26 to build movement heuristics for the traffic zone 20 using the movement data received from the first set of autonomous vehicles 18 (block 104). For instance, the processing circuitry 22 may populate the movement data heuristics buffer 28 with the received movement data. The processing circuitry 22 may invoke the pattern generation unit 24 to form (or generate) a traffic pattern (e.g., pattern 40) for the traffic zone 20 using heuristics available from the movement data heuristics buffer 28 (block 106).

In turn, the processing circuitry 22 may transmit the instructions that make up the pattern 40 to a second set of autonomous vehicles 18 traveling through traffic zone 20 (block 108). The second set of autonomous vehicles 18 may be different from the first set of autonomous vehicles 18 in some way. In some examples, there may be no overlap at all between the two sets, or some overlap that falls short of rendering the two sets identical. As used herein, two sets of vehicles are ‘identical’ if all of the vehicles of one set are included and also occupy the same position in the second set as they occupied in the first set. For instance, one or more vehicles in the first set of autonomous vehicles 18 may be included, at a different physical position, in the second set of autonomous vehicles 18.

According to the process 100, in some implementations, the pattern age unit 84 may determine an age of the pattern 40 (block 110). For instance, the pattern age unit 84 may compare the elapsed time from the generation of the pattern 40 until the time of age-checking against a threshold time. In various examples, the pattern age unit 84 may use a fixed predetermined threshold time or may dynamically generate the value of the threshold time based on one or more characteristics of the traffic zone 20, pattern 40, or other criteria.

Based on the determined age of the pattern 40, the pattern validity verification unit 86 may examine validity information that is currently available for the pattern 40 (block 112). As one example, the pattern validity verification unit 86 may mine data available from the system memory 26 if the pattern age unit 84 determines that the age of the pattern 40 exceeds the threshold age against which the age of the pattern 40 was compared. As described, the pattern validity verification unit 86 may examine the data available from the system memory 26 for any validity information generated and uploaded by a validity-checking authorized vehicle (e.g., autonomous vehicle 18N of FIG. 4) with respect to the pattern 40.

Based on the examination of validity information available with respect to the pattern 40, the pattern validity verification unit 86 may determine whether or not the pattern 40 is still valid (decision block 114). For instance, if the pattern validity verification unit 86 locates a validity verification as the most recently received and available validity information, then the pattern validity verification unit 86 determines that the pattern 40 is still valid with respect to the conditions at the traffic zone 20. In some examples, if the pattern validity verification unit 86 does not locate any validity information with respect to the pattern 40, then pattern validity verification unit 86 may infer that the pattern 40 is still valid with respect to the conditions at the traffic zone 20. Responsive to any of these validity-verifying events (block 114: YES), the pattern validity verification unit 86 may cause the processing circuitry 22 to transmit (via the communication unit 14) the instruction set of the pattern 40 to a third set of autonomous vehicles 18 traveling through the traffic zone 20 (block 116). The third set of autonomous vehicles 18 may be different from the first set of autonomous vehicles 18 and from the second set of autonomous vehicles 18, in accordance with the definition of “different” provided above.

If the pattern validity verification unit 86 locates a pattern invalidation as the most recently received and available validity information, then the pattern validity verification unit 86 may determine that the pattern 40 (or a portion thereof) is no longer valid with respect to the conditions at the traffic zone 20. In this event (block 114: NO), the pattern validity verification unit 86 may cause the processing circuitry 22 to cease transmitting the instruction set of the pattern 40 to vehicles traveling through the traffic zone 20 (block 118).

In some implementations, the server device 12 may, for some period of time, allow vehicles to travel through the traffic zone 20 using locally-implemented navigation logic, or by way of manual operation from a driver/occupant. In turn, the pattern generation unit 24 may form a new traffic pattern for the traffic zone 20 using movement data cached in the movement data heuristics buffer 28 (block 120). For instance, the pattern generation unit 24 may collect movement data that was received from vehicles traveling through the traffic zone 20 after the invalidation time of the pattern 40 to form the new pattern. In some examples, the pattern generation unit 24 may use the more recently received movement data in combination with some subset of data that was used for the formulation of the pattern 40, such as movement data of lanes that are unaffected by the events that caused the pattern 40 to be invalidated.

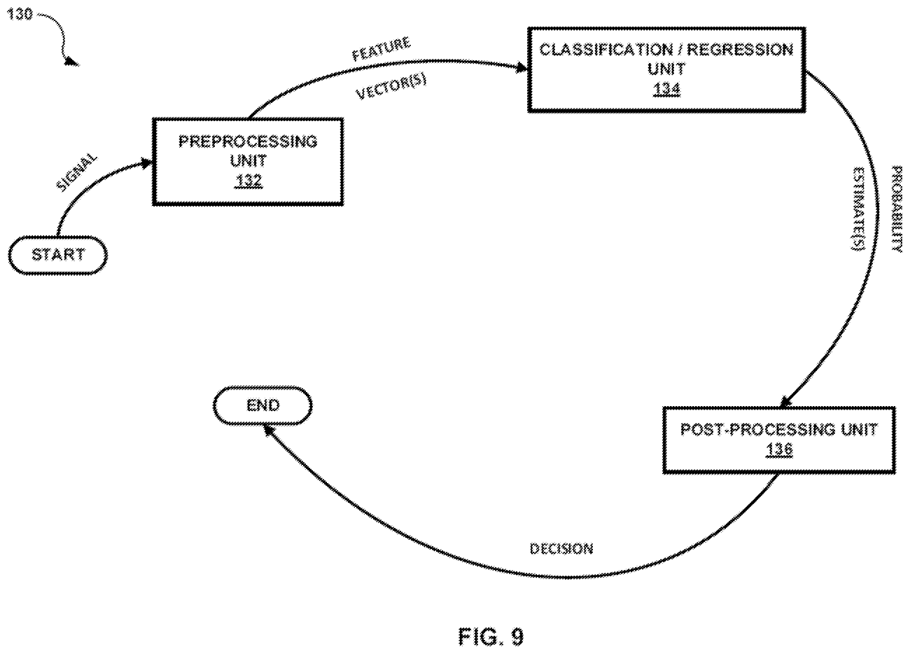

FIG. 9 is a data flow diagram (DFD) 130 that illustrates various pattern recognition functionalities implemented by systems of this disclosure. With reference to FIGS. 1-9, for instance, the processing circuitry 22 may implement various machine learning capabilities by performing the pattern recognition techniques shown in the DFD 130. Each block illustrated in the DFD 130 may represent a system component of the server device 12 and, as an example for discussion purposes, is described herein as being a unit included in the pattern generation unit 24. Other implementations are also possible.

At the start of DFD 130, preprocessing unit 132 of the pattern generation unit 24 may receive a signal. In some instances, the preprocessing unit 132 may perform feature extraction, in addition to other preprocessing aspects of the pattern recognition techniques of the DFD 130. The signal may represent raw data with respect to aspects of the pattern being analyzed. The preprocessing unit 132 may extract, from the raw data, features that are to be used in subsequent comparison steps of the pattern recognition techniques provided by the DFD 130. The preprocessing unit 132 may perform feature extraction in various ways, including (but not limited to) one or more of linear discriminant analysis (LDA), quadratic discriminant analysis, principal components analysis (PCA), kernelized LDA (KPCA), kernelized PCA (KPCA), maximum entropy classification, logistic regression, multinomial logistic regression, and/or the like. In turn, the preprocessing unit 132 may provide the extracted features, as one or more feature vectors, to classification/regression unit 134 of the pattern generation unit 24.

The classification/regression unit 134 may be configured to perform (but is not limited to) one or more of Gaussian process regression, Gaussian maximum likelihood estimation (Gaussian MLE), k nearest neighbors (kNN) classification, Gaussian mixture modeling (GMM), support vector machine (SVM), linear regression, neural networking, deep learning technology, independent component analysis, principal component analysis, and/or various other classification/regression techniques in accordance with pattern recognition technology. Based on the logic implemented, the classification/regression unit 134 may form one or more probability estimates with respect to individual vehicle movements to navigate the inferred/extrapolated traffic conditions at the traffic zone 20. The classification/regression unit 134 may provide the probability estimate(s) to post-processing unit 136 of the pattern generation unit 24.

The post-processing unit 136 of the pattern generation unit 24 may analyze the one or more received probability estimates to form decisions on one more movement instructions to be included in the pattern 40. For instance, the post-processing unit 136 may use various thresholding operations to determine whether certain probability estimates received from the classification/regression unit 134 meet certain criteria to be used in the formulation of movement instructions that are to be included in the pattern 40. The output of the decision information by the post-processing unit 136 indicates the end of the pattern recognition process illustrated in the DFD 130.

Each of the preprocessing unit 132, classification/regression unit 134, and post-processing unit 136 may be formed in one or more microprocessors, application specific integrated circuits (ASICs), field programmable gate arrays (FPGAs), digital signal processors (DSPs), processing circuitry (including fixed function circuitry and/or programmable processing circuitry), or other equivalent integrated logic circuitry or discrete logic circuitry. In various implementations, two or more of the preprocessing unit 132, classification/regression unit 134, and post-processing unit 136 may be integrated into a single unit, or each of preprocessing unit 132, classification/regression unit 134, and post-processing unit 136 may be may be a discrete, standalone component of the pattern generation unit 24.

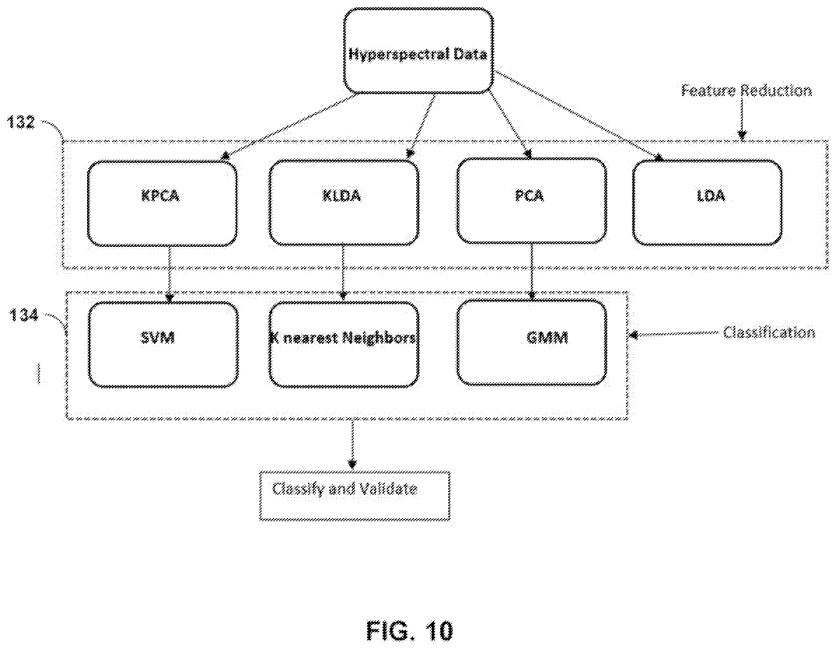

FIG. 10 is a conceptual diagram illustrating various technologies that the preprocessing unit 132 (FIG. 9) and classification/regression unit 134 (FIG. 9) may implement to perform aspects of pattern recognition and machine learning, in accordance with various implementations. With reference to FIGS. 1-10, as part of feature extraction to obtain feature vectors, the preprocessing unit 132 may implement one or more of LDA, PCA, KLDA, or KPCA (the expansions for which are provided above). As part of classification or prediction operations, the classification/regression unit 134 may implement one or more of Gaussian MLE, kNN, GMM, or SVM (the expansions for which are provided above). Table 1 below presents experimental results produced by various combinations of algorithms implemented by the preprocessing unit 132 and the classification/regression unit 134.

TABLE 1

| | Gaussian MLE | | kNN | | SVM | | GMM | |
|---|---|---|---|---|---|---|---|---|
| PCA | Dim = | 2, | Dim = | 2, | Dim = | 1, | Dim = | 2, |
| | Eff = | 44.3% | k = | 15, | Eff = | 27.5% | Eff = | 44.7% |
| | | | Eff = | 53.7% | | | | |
| LDA | Dim = | 2, | Dim = | 24 | Dim = | 6, | Dim = | 10 |
| | Eff = | 37.7% | k = | 5, | Eff = | 54% | Eff = | 54.8% |
| | | | Eff = | 64.5% | | | | |
| KDA | Dim = | 6 | Dim = | 5, | Dim = | 9 | Dim = | 6 |
| | Eff = | 41.5% | k = | 5 | Eff = | 56.8% | Eff = | 36% |
| | | | Eff = | 47.5% | | | | |
| KPCA | Dim = | 25 | Dim = | 4 | Dim = | 11 | Dim = | 12 |
| | Eff = | 52.5% | k = | 5 | Eff = | 53.5% | Eff = | 29% |
| | | | Eff = | 47% | | | | |

Each row of Table 1 corresponds to a single algorithm implemented by the preprocessing unit 132. Each column of Table 1 corresponds to a single algorithm implemented by the classification/regression unit 134. In each cell of Table 1, the term ‘Dim’ indicates a number of dimensions used in the implementation of the algorithm. The resulting efficiency is denoted by the term ‘Eff’ in each cell of Table 1. In the second column from the left, which corresponds to test cases in which the classification/regression unit 134 implements a kNN algorithm, the parameter ‘k’ indicates the number of neighboring samples considered in the respective experimental implementation.

As shown in Table 1, a combination of the preprocessing unit 132 implementing the LDA algorithm, with the classification/regression 134 implementing the kNN algorithm (with a ‘k’ value of 5) yields the greatest efficiency. That is, the greatest efficiency yielded via the particular set of experimental executions shown in Table 1 is 64.5%. In terms of the training data from which the pattern generation unit 24 selects data for pattern recognition and machine learning shown in Table 1, the pattern generation unit 24 may select from a total of 750 samples and a total of 360 dimensions (or channels). As used herein, a “sample” refers to a single vehicle, and a “channel” or “dimension” refers to a single variable uploaded by an individual sample. In the particular experimental run that yielded 64.5% efficiency, the pattern generation unit 24 funneled the 360 channels down to a subset of 24 channels. In various experimental runs shown in Table 1, the pattern generation unit 24 selects 5 samples from the training data universe of 750 samples.

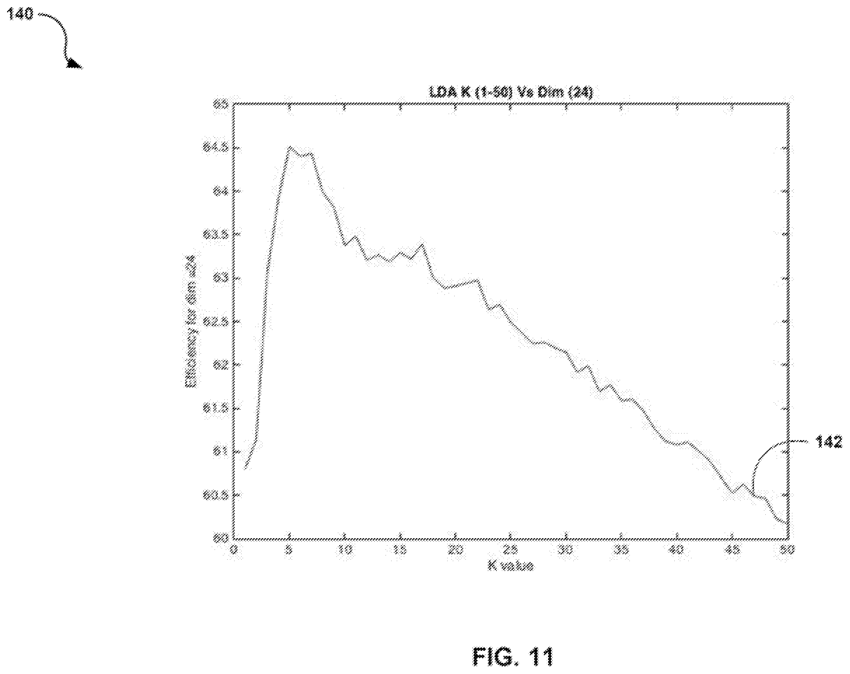

FIG. 11 illustrates a line graph 140 that plots an efficiency percentage against a combination of feature extraction and classification parameters, in one of the test cases shown in Table 1 above. With reference to FIGS. 1-11, more specifically, the line graph 140 corresponds to a set of test cases in which the preprocessing unit 132 implements the LDA feature extraction algorithm, and in which the pattern generation unit 24 uses a set of 24 dimensions/channels from the total available dimensions/channels (e.g., a total of 360 dimensions). The horizontal (x-) axis of the line graph 140 shows an incremented variation of the ‘k’ value that the classification/regression unit 134 uses in various test runs. As shown, the greatest efficiency (e.g., the highest peak on curve 142) corresponds to a ‘k’ value of 5 on the x-axis. That is, the greatest efficiency yielded by the LDA/kNN algorithm combination is 64.5%, which is the vertical (y-) axis coordinate of the highest peak of curve 142.

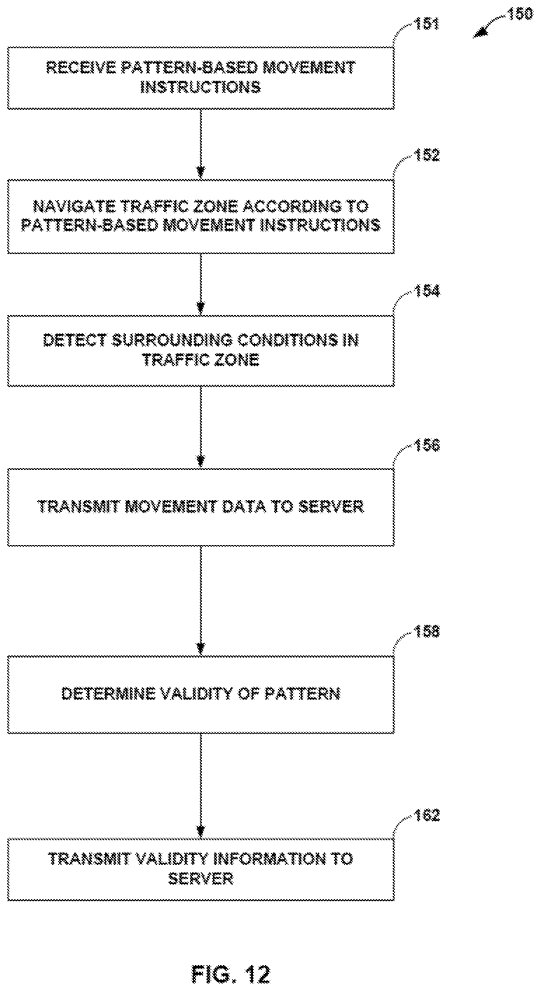

FIG. 12 is a flowchart illustrating a process 150 that a vehicle (e.g., autonomous vehicles 18) may perform, in accordance with various vehicle-side aspects of the techniques described herein. With reference to FIGS. 1-12, although a variety of vehicles may perform the process 150, or portions thereof, the process 150 is described herein as being performed by the autonomous vehicle 18N (refer to FIGS. 4 and 5). The process 150 may begin when the autonomous vehicle 18N receives, from the server device 12, movement instructions based on the pattern 40 (block 151). In turn, the autonomous vehicle 18N may navigate the traffic zone 20 based on the received movement instructions (block 152). In some implementations, using the sensor hardware 62-68, the autonomous vehicle 18N may detect conditions surrounding the autonomous vehicle 18N in the traffic zone 20 (block 154).

The autonomous vehicle 18N may also transmit movement data to the server device 12 (block 156). That is, the autonomous vehicle 18N may continue the crowdsourcing aspects of movement data gathering described according to various implementations. Based on the information of the surrounding conditions gathered via the sensor hardware 62-68, the autonomous vehicle 18N may determine whether the pattern 40 is still valid with respect to the prevailing conditions at the traffic zone 20 (block 158). In turn, the autonomous vehicle 18N may transmit the validity information to the server device 12, via the wireless network 16 (block 162). It will be appreciated that the various steps of the process 150 are illustrated in FIG. 12 in a particular order as an example, and that autonomous vehicle 18N may perform the blocks of the process 150 in different orders (as well as excluding blocks) than the order illustrated.

The crowdsourcing-based traffic management technologies of this disclosure provide several potential advantages. On example is fault-tolerance or robustness. That is, vehicles traveling according to instructions of a pattern generated by server device 12 represents a traffic flow scheme that is comparable to a single distributed system. Single distributed systems tend to display greater fault tolerance that the alternatives. That is, in the case of traffic flow management, a holistically-managed, pattern-based set of movement instructions may mitigate or potentially minimize accidents, based on the synchrony and compatibility of the movement instructions provided to the vehicles traveling through the traffic zone for which the pattern was generated.

Another potential advantage of the various implementations is information reusability. Because multiple vehicles of different sets may reuse movement instructions of a single pattern, the regeneration of navigation instructions, whether locally at the vehicles, or remotely at server device 12, is reduced. For instance, in the nine-car pattern scenarios discussed above, the processing circuitry 22 may use the above-described pattern recognition and pattern generation algorithms to reduce processing redundancy nine-fold.

Another potential advantage of the various implementations is a faster response or reduced response time to traffic conditions at the vehicle level. As opposed to obstacle-to-car or car-to-car communications that might become necessary in a non-server-based solution, the various described implementations reduce or potentially minimize processing at the vehicle-level. While some vehicles implement local processing to determine validity information of a pattern, the vehicle response to local transmissions may become faster according to the systems of this disclosure. Another potential advantage of the various implementations is power saving. Due to the reduced vehicle-level processing at the vehicle level, each vehicle may reduce power expenditure, thereby reducing battery usage and prolonging battery life (e.g., enabling longer travel distances without the need to recharge or replace batteries).

Another potential advantage of the various described implementations is adaptability at the vehicle level. For instance, the systems of this disclosure may enable each individual vehicle in a traffic zone to better adapt to the introduction of a new obstacle or stimulus. For example, the server device 12 may determine a new pattern based on crowdsourced information that indicates the presence of the stimulus/obstacle, and the new pattern provides movement instructions that enable each vehicle to react to the new stimuli or obstacles, dynamically.

Various embodiments illustrated and described are provided merely as examples to illustrate various features of the claims. However, features shown and described with respect to any given embodiment are not necessarily limited to the associated embodiment and may be used or combined with other embodiments that are shown and described. Further, the claims are not intended to be limited by any one example embodiment.

The foregoing method descriptions and the process flow diagrams are provided merely as illustrative examples and are not intended to require or imply that the blocks of various embodiments must be performed in the order presented. As will be appreciated by one of skill in the art the order of blocks in the foregoing embodiments may be performed in any order. Words such as “thereafter,” “then,” “next,” etc. are not intended to limit the order of the blocks; these words are simply used to guide the reader through the description of the methods. Further, any reference to claim elements in the singular, for example, using the articles “a,” “an,” or “the” is not to be construed as limiting the element to the singular.

The various illustrative logical blocks, modules, circuits, and algorithm blocks described in connection with the embodiments disclosed herein may be implemented as electronic hardware, computer software, or combinations of both. To clearly illustrate this interchangeability of hardware and software, various illustrative components, blocks, modules, circuits, and blocks have been described above generally in terms of their functionality. Whether such functionality is implemented as hardware or software depends upon the particular application and design constraints imposed on the overall system. Skilled artisans may implement the described functionality in varying ways for each particular application, but such embodiment decisions should not be interpreted as causing a departure from the scope of various embodiments.

The hardware used to implement the various illustrative logics, logical blocks, modules, and circuits described in connection with the embodiments disclosed herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of communication devices, e.g., a combination of a DSP and a microprocessor, a plurality of microprocessors, one or more microprocessors in conjunction with a DSP core, or any other such configuration. Alternatively, some blocks or methods may be performed by circuitry that is specific to a given function.

In various embodiments, the functions described may be implemented in hardware, software, firmware, or any combination thereof. If implemented in software, the functions may be stored as one or more instructions or code on a non-transitory computer-readable medium or non-transitory processor-readable medium. The operations of a method or algorithm disclosed herein may be embodied in a processor-executable software module, which may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable media may include RAM, ROM, EEPROM, FLASH memory, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable medium and/or computer-readable medium, which may be incorporated into a computer program product.

The preceding description of the disclosed embodiments is provided to enable any person skilled in the art to make or use the present embodiments. Various modifications to these embodiments will be readily apparent to those skilled in the art, and the generic principles defined herein may be applied to other embodiments without departing from the scope of the embodiments. Thus, various embodiments are not intended to be limited to the embodiments shown herein but are to be accorded the widest scope consistent with the following claims and the principles and novel features disclosed herein.

What is claimed is:

1. A server device for managing vehicles, comprising:
a communication unit configured to receive movement data from a first set of vehicles traveling through a traffic zone;
and
processing circuitry coupled to the communication unit, the processing circuitry being configured to:
determine a traffic pattern for the traffic zone based at least in part on the movement data;
generate movement instructions for the traffic zone based at least in part on the determined traffic pattern; and
transmit, via the communication unit, the movement instructions to a second set of vehicles traveling through the traffic zone, the second set of vehicles being different from the first set of vehicles.

2. The server device of claim 1, wherein the determined traffic pattern is a first traffic pattern,
the processing circuit being further configured to:
determine whether the first traffic pattern is valid or invalid; and
responsive to determining that the first traffic pattern is invalid, determine a second traffic pattern for the traffic zone, the second traffic pattern being different from the first traffic pattern.

3. The server device of claim 2, wherein the generated movement instructions are first movement instructions,
the processing circuit being further configured to:
generate second movement instructions for the traffic zone based at least on the determined second traffic pattern; and
transmit, via the communication unit, the second movement instructions to a third set of vehicles traveling through the traffic zone, the third set of vehicles being different from the first set of vehicles and the second set of vehicles.

4. The server device of claim 2, wherein the processing circuit is configured to determine whether the first traffic pattern is valid or invalid based on age of the first traffic pattern or the movement data used to generate at least part of the first traffic pattern.

5. The server device of claim 1, wherein the determined traffic pattern is a first traffic pattern,
the processing circuit being further configured to:
determine whether the first traffic pattern is valid or invalid; and
responsive to determining that the first traffic pattern is invalid, determine a second traffic pattern for the traffic zone, cease transmitting the movement instructions.

6. The server device of claim 1, wherein the determined traffic pattern is a first traffic pattern,
the communication unit being further configured to receive, from at least a portion of the second set of vehicles traveling through the traffic zone, validity information indicating whether the first traffic pattern is valid or invalid;
the processing circuitry being further configured to, responsive to the validity information indicating that the first traffic pattern is invalid, determine a second traffic pattern for the traffic zone, the second traffic pattern being different from the first traffic pattern.

7. The server device of claim 6, wherein the generated movement instructions are first movement instructions,
the processing circuit being further configured to:
generate second movement instructions for the traffic zone based at least on the determined second traffic pattern; and
transmit, via the communication unit, the second movement instructions to a third set of vehicles traveling through the traffic zone, the third set of vehicles being different from the first set of vehicles and the second set of vehicles.

8. The server device of claim 1, wherein:
the communication unit being further configured to receive, from at least a portion of the second set of vehicles traveling through the traffic zone, validity information indicating whether the traffic pattern is valid or invalid;
the processing circuitry being further configured to, responsive to the validity information indicating that the traffic pattern is invalid, cease transmitting the movement instructions.

9. The server device of claim 1, wherein to generate the movement instructions for the traffic zone based at least in part on the determined traffic pattern, the processing circuitry is configured to:
generate each respective movement instruction of the movement instructions based on a corresponding movement of the traffic pattern that is associated with a corresponding location associated with the respective movement instruction being generated.

10. The server device of claim 1, wherein to transmit the movement instructions to the second set of vehicles traveling through the traffic zone, the processing circuitry is configured to:
associate a respective subset of the movement instructions with a respective vehicle of the second set of vehicles; and
transmit only the respective subset of the movement instructions to the respective associated vehicle.

11. The server device of claim 1, wherein to transmit the movement instructions to the second set of vehicles traveling through the traffic zone, the processing circuitry is configured to transmit the movement instructions to each vehicle of the second set of vehicles.

12. A vehicle comprising:
a communication unit configured to receive movement instructions from a server device, the movement instructions being associated with a traffic zone;
sensor hardware configured to detect surrounding conditions in or near the traffic zone; and
processing circuitry coupled to the sensor hardware and to the communication unit, the processing circuitry being configured to:
cause the vehicle to travel in the traffic zone based on the received movement instructions;
determine movement data for the traffic zone based on the detected surrounding conditions; and
transmit, via the communication unit, the movement data to the server device.

13. The vehicle of claim 12, the processing circuitry being further configured to:
determine, based on the detected surrounding conditions, whether the received movement instructions are valid with respect to the traffic zone; and
transmit, via the communication unit to the server device, validity information based on the determination of whether the received movement instructions are valid.

14. The vehicle of claim 13,
wherein the received movement instructions are associated with a traffic pattern, and
wherein the validity information indicates whether the traffic pattern is valid with respect to the traffic zone.

15. A method for managing vehicles via a server device, comprising:
receiving, via a communication unit of the server device, movement data from a first set of vehicles traveling through a traffic zone;
determining, via a processing unit of the server device, a traffic pattern for the traffic zone based at least in part on the movement data;
generating, via the processing unit, movement instructions for the traffic zone based at least in part on the determined traffic pattern; and
transmitting the movement instructions to a second set of vehicles traveling through the traffic zone, the second set of vehicles being different from the first set of vehicles.

16. The method of claim 15, wherein the determined traffic pattern is a first traffic pattern, the method further comprising:
determining whether the first traffic pattern is valid or invalid;
responsive to determining that the first traffic pattern is invalid, determining a second traffic pattern for the traffic zone, the second traffic pattern being different from the first traffic pattern.

17. The method of claim 16, wherein the generated movement instructions are first movement instructions, the method further comprising:
generating second movement instructions for the traffic zone based at least on the determined second traffic pattern; and
transmitting the second movement instructions to a third set of vehicles traveling through the traffic zone, the third set of vehicles being different from the first set of vehicles and the second set of vehicles.

18. The method of claim 16, wherein determining whether the first traffic pattern is valid or invalid is based on age of the first traffic pattern or the movement data used to generate at least part of the first traffic pattern.

19. The method of claim 15, wherein the determined traffic pattern is a first traffic pattern, the method further comprising:
determining whether the first traffic pattern is valid or invalid;
responsive to determining that the first traffic pattern is invalid, determining a second traffic pattern for the traffic zone, cease transmitting the movement instructions.

20. The method of claim 15, wherein the determined traffic pattern is a first traffic pattern, the method further comprising:
receiving, from at least a portion of the second set of vehicles traveling through the traffic zone, validity information indicating whether the first traffic pattern is valid or invalid;
responsive to the validity information indicating that the first traffic pattern is invalid, determining a second traffic pattern for the traffic zone, the second traffic pattern being different from the first traffic pattern.

21. The method of claim 20, wherein the generated movement instructions are first movement instructions, the method further comprising:
generating second movement instructions for the traffic zone based at least on the determined second traffic pattern; and
transmitting the second movement instructions to a third set of vehicles traveling through the traffic zone, the third set of vehicles being different from the first set of vehicles and the second set of vehicles.

22. The method of claim 15, the method further comprising:
receiving, from at least a portion of the second set of vehicles traveling through the traffic zone, validity information indicating whether the traffic pattern is valid or invalid;
responsive to the validity information indicating that the traffic pattern is invalid, ceasing transmission of the movement instructions.

23. The method of claim 15, wherein generating the movement instructions for the traffic zone based at least in part on the determined traffic pattern comprises
generating each respective movement instruction of the movement instructions based on a corresponding movement of the traffic pattern that is associated with a corresponding location associated with the respective movement instruction being generated.

24. The method of claim 15, wherein transmitting the movement instructions to the second set of vehicles traveling through the traffic zone comprises:
associating a respective subset of the movement instructions with a respective vehicle of the second set of vehicles; and
transmitting only the respective subset of the movement instructions to the respective associated vehicle.

25. The method of claim 15, wherein transmitting the movement instructions to the second set of vehicles traveling through the traffic zone comprises transmitting the movement instructions to each vehicle of the second set.

26. A method for managing a vehicle, comprising:
receiving, via a communication unit of the vehicle, movement instructions from a server device, the movement instructions being associated with a traffic zone;
detecting, via sensor hardware of the vehicle, surrounding conditions in or near the traffic zone;
causing, via a processing unit of the vehicle, the vehicle to travel in the traffic zone based on the received movement instructions;
determining, via the processing unit of the vehicle, movement data for the traffic zone based on the detected surrounding conditions; and
transmitting the movement data to the server device.

27. The method of claim 26, the method further comprising:
determining, based on the detected surrounding conditions, whether the received movement instructions are valid with respect to the traffic zone; and
transmitting validity information based on the determination of whether the received movement instructions are valid.

28. The method of claim 27,
wherein the received movement instructions are associated with a traffic pattern and,
wherein the validity information indicates whether the traffic pattern is valid with respect to the traffic zone.
